(19) United States
(12) Patent Application Publication
(10) Pub. No.: US 2018/0265661 A1
(43) Pub. Date: Sep. 20, 2018

(54) EXTRUDED STYRENE RESIN FOAM AND METHOD FOR PRODUCING SAME

(71) Applicant: Kaneka Corporation, Osaka (JP)

(72) Inventors: Takenori Kikuchi, Osaka (JP); Shunji Kurihara, Osaka (JP); Koji Shimizu, Osaka (JP)

(73) Assignee: Kaneka Corporation, Osaka (JP)

(21) Appl. No.: 15/983,938

(22) Filed: May 18, 2018

Related U.S. Application Data
(63) Continuation of application No. PCT/JP2016/082689, filed on Nov. 2, 2016.

(30) Foreign Application Priority Data
Nov. 20, 2015 (JP) 2015-227905

(51) Int. Cl. C08J 9/00; B29C 47/00

(52) U.S. Cl. CPC C08J 9/0019; C08J 9/0023; C08J 9/0061; C08J 9/0071; C08J 9/0038; B29K 2025/06; B29C 47/0066; B29C 47/0042; C08J 2205/052; C08J 2325/06; C08J 2453/02; B29C 47/0004

(57) ABSTRACT

A styrene resin extruded foam includes a styrene resin, a flame retarder, a hydrofluoroolefin, an alcohol, and at least one selected from the group consisting of a saturated hydrocarbon having 3 to 5 carbon atoms, dimethyl ether, and alkyl chloride. An amount of the flame retarder is 0.5 to 8.0 parts by weight relative to 100 parts by weight of the styrene resin. The styrene resin extruded foam has an apparent density of 20 to 45 kg/m³ and a closed cell ratio of not less than 90%. An amount of the hydrofluoroolefin added is 65 to 90 mol % relative to 100 mol % in total of the hydrofluoroolefin and the alcohol which are added. An amount of the alcohol added is 10 to 35 mol % relative to 100 mol % in total of the hydrofluoroolefin and the alcohol which are added.

### TECHNICAL FIELD

One or more embodiments of the present invention relate to a styrene resin extruded foam which is obtained by extrusion foaming with use of a styrene resin and a foaming agent. One or more embodiments of the present invention further relate to a method for producing such a styrene resin extruded foam.

### BACKGROUND

In general, a styrene resin extruded foam is continuously produced by (i) heating a styrene resin composition with use of an extruder or the like so that the styrene resin composition is melted, (ii) adding a foaming agent to a molten styrene resin composition under a high pressure condition, (iii) cooling a resultant mixture to a given resin temperature, and then (iv) extruding the mixture to a low pressure region.

A styrene resin extruded foam is used as, for example, a heat insulating material for a structure, because the styrene resin extruded foam is good in workability and heat insulating property. In recent years, there has been an increasing demand for energy conservation in houses, buildings, and the like. Under the circumstances, technical development of a foam that is higher in heat insulating property than a conventional foam has been desired.

As a method for producing a highly heat insulating foam, the following methods have been suggested: a method in which a cell diameter of an extruded foam is controlled to fall within a given range; a method in which a heat ray radiation inhibitor is used; and a method in which a foaming agent having a low thermal conductivity is used.

For example, Patent Literature 1 suggests a production method in which (i) fine cells, having an average cell diameter of 0.05 mm to 0.18 mm in a thickness direction of an extruded foam, are formed and (ii) a cell deformation ratio of the extruded foam is further controlled.

Patent Literature 2 suggests a production method in which, as a heat ray radiation inhibitor, graphite or titanium oxide is used in an amount falling within a given range.

Furthermore, a method for producing a styrene resin extruded foam is suggested in which an environmentally friendly fluorinated olefin (also referred to as a hydrofluoroolefin or HFO) whose ozone depleting potential is 0 (zero) and whose global warming potential is also low is used (see, for example, Patent Literatures 3 through 7). Meanwhile, Patent Literatures 5 and 6 each deal with an example in which a hydrofluoroolefin and ethanol are used in combination.

### CITATION LIST

### Patent Literature

[Patent Literature 1]

Japanese Patent Application Publication, Tokukai, No. 2004-59595

[Patent Literature 2]

Japanese Patent Application Publication, Tokukai, No. 2013-221110

[Patent Literature 3]

Published Japanese Translation of PCT International Application, Tokuhyo, No. 2008-546892

[Patent Literature 4]

Japanese Patent Application Publication, Tokukai, No. 2013-194101

[Patent Literature 5]

Published Japanese Translation of PCT International Application, Tokuhyo, No. 2012-516381

[Patent Literature 6]

Published Japanese Translation of PCT International Application, Tokuhyo, No. 2010-522808

[Patent Literature 7]

PCT International Publication No. WO 2015/093195

However, the techniques disclosed in Patent Literatures 1 through 7 are not sufficient in terms of obtainment of a styrene resin extruded foam which has an excellent heat insulating property, an excellent flame retardancy, a beautiful appearance, and a sufficient thickness suitable for use.

### SUMMARY

One or more embodiments of the present invention relate to a styrene resin extruded foam which has an excellent heat insulating property, an excellent flame retardancy, a beautiful appearance, and a sufficient thickness suitable for use.

The inventors conducted a diligent study, and completed one or more embodiments of the present invention.

In other words, one or more embodiments of the present invention have the following feature.

[1] A styrene resin extruded foam including: not less than 0.5 parts by weight and not more than 8.0 parts by weight of a flame retarder relative to 100 parts by weight of a styrene resin; a hydrofluoroolefin; an alcohol; and at least one selected from the group consisting of a saturated hydrocarbon having 3 to 5 carbon atoms, dimethyl ether, and alkyl chloride, the styrene resin extruded foam having an apparent density of not less than 20 kg/m³ and not more than 45 kg/m³ and a closed cell ratio of not less than 90%, an amount of the hydrofluoroolefin added being not less than 65 mol % and not more than 90 mol %, relative to 100 mol % in total of the hydrofluoroolefin and the alcohol which are added, and an amount of the alcohol added being not less than 10 mol % and not more than 35 mol %, relative to 100 mol % in total of the hydrofluoroolefin and the alcohol which are added.

According to one or more embodiments of the present invention, it is possible to easily obtain a styrene resin extruded foam which has an excellent heat insulating property, an excellent flame retardancy, a beautiful appearance, and a sufficient thickness suitable for use.

### DETAILED DESCRIPTION OF THE EMBODIMENTS

The following description will discuss one or more embodiments of the present invention. However, the present invention is not limited to the embodiment. The present invention is not limited to arrangements described below, but may be altered in various ways by a skilled person within the scope of the claims. Any embodiment and/or an example derived from a proper combination of technical means disclosed in different embodiments and/or examples are/is also encompassed in the technical scope of the present invention. All academic and patent literatures listed herein are incorporated herein by reference. Unless otherwise specified herein, a numerical range expressed as “A to B” means “not less than A (equal to or more than A) and not more than B (equal to or less than B)”.

The inventors conducted a diligent study about Patent Literatures 1 through 7. Specifically, first, according to the technique disclosed in Patent Literature 1, in a case where an average cell diameter is caused to fall within a fine range, a distance between cell walls in a foam becomes shorter. Accordingly, since a range of movement of cells is narrow during impartation of a shape by extrusion foaming, it is difficult to deform the cells. This disadvantageously makes it difficult to (i) impart a beautiful surface to an extruded foam and (ii) increase a thickness of the extruded foam.

Next, according to the technique disclosed in Patent Literature 2, in a case where a solid additive is used in a large amount, cells in a foam become fine due to an increase in the number of nucleating points, and these are similar to those seen in the technique disclosed in Patent Literature 1. In addition, a resin itself becomes poor in stretch. This disadvantageously makes it more difficult to (i) impart a beautiful surface to an extruded foam and (ii) increase a thickness of the extruded foam.

According to the techniques disclosed in Patent Literatures 3 through 7, a hydrofluoroolefin is used. The hydrofluoroolefin, used in these conventional techniques, has low solubility in a styrene resin, and is rapidly separated from the styrene resin during extrusion foaming. Such a separated hydrofluoroolefin becomes a nucleating point, and causes a cell diameter to be fine. Furthermore, due to latent heat of vaporization of the hydrofluoroolefin, a resin is cooled and solidified (the resin becomes poor in stretch). As such, these are similar to those seen in the technique disclosed in Patent Literature 1.

Note that Patent Literatures 5 and 6 each disclose, as an example, a technique in which a hydrofluoroolefin and ethanol are used in combination. However, in a case where the hydrofluoroolefin and the ethanol are mixed in amounts falling within respective ranges specified in each of Patent Literature 5 and 6, it is not possible to impart a suitable flame retardancy to an extruded foam. Further, in such a case, no significant moldability improving effect is produced.

As has been described, according to the conventional techniques each for producing a highly heat insulating foam, since (i) during molding of an extruded foam by extrusion foaming, cells in the extruded foam are prevented from being deformed and/or (ii) a resin itself is poor in stretch, it is difficult to impart a beautiful surface to the extruded foam and to increase a thickness of the extruded foam. Therefore, the conventional techniques, each for producing a highly heat insulating foam, have not yet reached a point where a styrene resin extruded foam which has (a) an excellent heat insulating property, (b) an excellent flame retardancy, and (c) a beautiful appearance and/or a sufficient thickness is easily obtained.

One or more embodiments of the present invention will be described below.

[1. Styrene Resin Extruded Foam]

A styrene resin extruded foam in accordance with one or more embodiments of the present invention is a styrene resin extruded foam including: not less than 0.5 parts by weight and not more than 8.0 parts by weight of a flame retarder relative to 100 parts by weight of a styrene resin; a hydrofluoroolefin; an alcohol; and at least one selected from the group consisting of a saturated hydrocarbon having 3 to 5 carbon atoms, dimethyl ether, and alkyl chloride, the styrene resin extruded foam having an apparent density of not less than 20 kg/m³ and not more than 45 kg/m³ and a closed cell ratio of not less than 90%, an amount of the hydrofluoroolefin added being not less than 65 mol % and not more than 90 mol %, relative to 100 mol % in total of the hydrofluoroolefin and the alcohol which are added, and an amount of the alcohol added being not less than 10 mol % and not more than 35 mol %, relative to 100 mol % in total of the hydrofluoroolefin and the alcohol which are added. The styrene resin extruded foam can be continuously produced as follows. First, a styrene resin composition which further contains, as necessary, another additive in an appropriate amount is heated and melted with use of an extruder or the like, that is, a molten resin is obtained. Next, a foaming agent is added to the molten resin under a high pressure condition, and the molten resin to which the foaming agent is added is cooled to a given resin temperature. Thereafter, the molten resin which contains the foaming agent is extruded to a low pressure region, so that the styrene resin extruded foam is foamed.

(1-1. Components)

The styrene resin used in one or more embodiments of the present invention is not limited to any particular one. Examples of the styrene resin encompass: (i) homopolymers each formed from a styrene monomer, such as styrene, methylstyrene, ethylstyrene, isopropyl styrene, dimethylstyrene, bromostyrene, chlorostyrene, vinyltoluene, or vinyl xylene, and copolymers each formed from a combination of two or more of such styrene monomers; and (ii) copolymers each formed through copolymerization of (a) such a styrene monomer and (b) one or more of monomers such as divinylbenzene, butadiene, acrylic acid, methacrylic acid, methyl acrylate, methyl methacrylate, acrylonitrile, maleic anhydride, and itaconic anhydride. Note that it is possible to use a monomer(s), such as acrylic acid, methacrylic acid, methyl acrylate, methyl methacrylate, maleic anhydride, and/or itaconic anhydride, which is/are copolymerized with a styrene monomer, in an amount(s) that does/do not decrease physical properties, such as compressive strength, of the styrene resin extruded foam to be produced. Note also that the styrene resin used in one or more embodiments of the present invention is not limited to the above homopolymers and copolymers. Alternatively, the styrene resin can be a styrene resin obtained by blending any of (i) a homopolymer formed from a styrene monomer, (ii) a copolymer formed from two or more kinds of styrene monomers, (iii) a homopolymer formed from a monomer other than a styrene monomer, and (iv) a copolymer formed from a styrene monomer and one or more kinds of monomer(s) other than a styrene monomer. For example, the styrene resin used in one or more embodiments of the present invention can be a styrene resin obtained by blending (i) a homopolymer or a copolymer each formed from a styrene monomer(s) and (ii) diene rubber-reinforced polystyrene or acrylic rubber-reinforced polystyrene. Note also that the styrene resin used in one or more embodiments of the present invention can be a styrene resin having a branched structure, for the purpose of adjustment of a melt flow rate (hereinafter, referred to as an MFR), a melt viscosity during molding, a melt tension during the molding, and the like.

The styrene resin used in one or more embodiments of the present invention may have a MFR of 0.1 g/10 minutes to 50 g/10 minutes, because such a styrene resin brings about the following advantages: (i) the moldability during the extrusion foaming molding is excellent; (ii) it is easy to adjust, to a desired quantity, a discharge quantity during the molding, and it is easy to adjust, to respective desired values, a thickness, a width, an apparent density, and a closed cell ratio of the styrene resin extruded foam to be obtained; (iii) foamability is excellent (it is easy to adjust, to desired values or a desired property, the thickness, the width, the apparent density, the closed cell ratio, a surface property, and the like of the foam); (iv) the styrene resin extruded foam which is excellent in appearance and the like is obtained; and (v) the styrene resin extruded foam which is balanced in terms of characteristics (for example, mechanical strength or toughness, such as compressive strength, bending strength, or an amount of bending deflection) is obtained. In view of balance between (i) the moldability and the foamability and (ii) the mechanical strength and the toughness, the styrene resin may also have a MFR of 0.3 g/10 minutes to 30 g/10 minutes, or 0.5 g/10 minutes to 25 g/10 minutes. Note that, in one or more embodiments of the present invention, the MFR is measured by the method A under the test condition H as specified in JIS K7210 (1999).

In one or more embodiments of the present invention, of the foregoing styrene resins, a polystyrene resin is particularly suitable in view of cost effectiveness and processability. In a case where the extruded foam is required to have higher heat resistance, it may be possible to use a styrene-acrylonitrile copolymer, (meth)acrylate copolymerized polystyrene, and/or maleic anhydride modified polystyrene. In a case where the extruded foam is required to have higher impact resistance, it may be possible to use rubber-reinforced polystyrene. Each of these styrene resins can be used solely. Alternatively, two or more of these styrene resins, which are different in copolymer component, molecular weight, molecular weight distribution, branched structure, MFR, and/or like, can be used in combination.

(1-1-3. Foaming Agent)

In one or more embodiments of the present invention, (i) a hydrofluoroolefin, which is used as a foaming agent, and an alcohol are added at molar ratios in specific ranges, respectively, and (ii) at least one selected from the group consisting of a saturated hydrocarbon having 3 to 5 carbon atoms, dimethyl ether, and alkyl chloride is used. Though use of the hydrofluoroolefin as a foaming agent deteriorates a shape, a surface property and a thickness increasing property (which are hereinafter collectively referred to as “moldability”) of an extruded foam, such one or more embodiments of the present invention arranged as above make it possible to improve the moldability of the extruded foam. In a case where an extruded foam is produced by using (i) the hydrofluoroolefin and the alcohol at molar ratios which fall within specific ranges, respectively, and (ii) at least one selected from the group consisting of a saturated hydrocarbon having 3 to 5 carbon atoms, dimethyl ether, and alkyl chloride, the following is inferred regarding a moldability improving effect on the extruded foam. That is, in a case where an alcohol soluble in both a styrene resin and a hydrofluoroolefin is used in combination with the hydrofluoroolefin such that the molar ratio of the hydrofluoroolefin and the molar ratio of the alcohol fall within specific ranges, respectively, the alcohol functions like a so-called compatibilizing agent. This enhances dispersibility and solubility of the hydrofluoroolefin in a molten resin. In a case where the dispersibility and the solubility of the hydrofluoroolefin in the molten resin is enhanced, an amount of the foaming agent which vaporizes immediately after the extruded foam is formed by foaming of the molten resin or a speed at which the foaming agent vaporizes immediately after the extruded foam is formed by the foaming of the molten resin are suppressed. This makes it possible to, at a subsequent molding timing, (i) maintain a plasticizing effect on the molten resin, which plasticizing effect is brought about by the foaming agent that remains in the molten resin, and (ii) suppress cooling and solidification of the molten resin, which cooling and solidification are caused by latent heat of vaporization of the foaming agent. As a result, it is considered that the extruded foam and/or the molten resin have/has sufficient plasticity during impartation of a shape to the extruded foam and/or the molten resin. Meanwhile, use of only the hydrofluoroolefin and the alcohol results in an excessive amount of the alcohol (or an excessive amount of the alcohol remaining in the extruded foam) in making a desired foam structure. This deteriorates flame retardancy of the extruded foam. In light of this, a saturated hydrocarbon having 3 to 5 carbon atoms, dimethyl ether, and/or alkyl chloride, each of which is capable of improving foamability and moldability of a styrene resin extruded foam is used in combination with the hydrofluoroolefin and the alcohol so as to produce a synergistic effect. With the synergistic effect, it is possible to impart suitable flame retardancy to the extruded foam while the extruded foam can have a desired feature.

The hydrofluoroolefin used in one or more embodiments of the present invention is not limited in particular. However, a tetrafluoropropene may be used because the tetrafluoropropene has a low thermal conductivity in a gaseous state and is safe. Specific examples of the tetrafluoropropene encompass trans-1,3,3,3-tetrafluoropropene (trans-HFO-1234ze), cis-1,3,3,3-tetrafluoropropene (cis-HFO-1234ze), and 2,3,3,3-tetrafluoropropene (trans-HFO-1234yf). Each of these hydrofluoroolefins can be used solely. Alternatively, two or more of these hydrofluoroolefins can be used in combination.

The hydrofluoroolefin in accordance with one or more embodiments of the present invention may be added in an amount of not less than 3.0 parts by weight and not more than 14.0 parts by weight, not less than 4.0 parts by weight and not more than 13.0 parts by weight, or not less than 4.5 parts by weight and not more than 12.0 parts by weight, relative to 100 parts by weight of the styrene resin. In a case where the amount of the hydrofluoroolefin is less than 3.0 parts by weight relative to 100 parts by weight of the styrene resin, a heat insulating property enhancing effect of the hydrofluoroolefin cannot be expected much. In a case where the amount of the hydrofluoroolefin is more than 14.0 parts by weight relative to 100 parts by weight of the styrene resin, the hydrofluoroolefin is separated from the molten resin during the extrusion foaming. This may cause a spot hole (a hole made in a case where a partial mass of the hydrofluoroolefin crashes through the surface of the extruded foam and goes out to external air) on the surface of the extruded foam or may cause a decrease in the closed cell ratio so that the heat insulating property is impaired.

Ozone layer depleting potential of the hydrofluoroolefin is zero or extremely low. Furthermore, global warming potential of the hydrofluoroolefin is very low. Therefore, the hydrofluoroolefin is an environmentally friendly foaming agent. Moreover, the hydrofluoroolefin has a low thermal conductivity in a gaseous state, and has flame retardancy. Therefore, by using the hydrofluoroolefin as the foaming agent of the styrene resin extruded foam, it is possible to cause the styrene resin extruded foam to have an excellent heat insulating property and an excellent flame retardancy.

In a case where the hydrofluoroolefin, such as the tetrafluoropropene, which has low solubility in the styrene resin is used, the hydrofluoroolefin is separated from the molten resin and/or vaporizes as the amount of the hydrofluoroolefin is increased. This causes (i) the hydrofluoroolefin, having been separated from the molten resin and/or having vaporized, to be a nucleating point, so that cells in the foam become fine, (ii) a decrease in the plasticizing effect on the molten resin due to a decrease in an amount of the foaming agent remaining in the resin, and (iii) the molten resin to be cooled and solidified due to latent heat of vaporization of the foaming agent. As a result, it tends to be difficult to (a) impart a beautiful surface to the extruded foam and (b) increase the thickness of the extruded foam. In particular, as has been described, in a case where the amount of the hydrofluoroolefin is more than 14.0 parts by weight relative to 100 parts by weight of the styrene resin, the moldability is considerably deteriorated because, in addition to the above disadvantages (i) through (iii), the spot hole further occurs on the surface of the extruded foam.

The alcohol used in one or more embodiments of the present invention is not limited in particular. However, it may be possible to use a saturated alcohol having 1 to 4 carbon atoms, such as methanol, ethanol, propyl alcohol, i-propyl alcohol, butyl alcohol, i-butyl alcohol, or tert-butyl alcohol because such a saturated alcohol has a high moldability improving effect on the extruded foam. Of these saturated alcohols, ethanol, propyl alcohol, and i-propyl alcohol may be used in view of availability and cost.

The alcohol in accordance with one or more embodiments of the present invention may be added in an amount of not less than 0.2 parts by weight and not more than 3.0 parts by weight, not less than 0.3 parts by weight and not more than 2.0 parts by weight, or not less than 0.4 parts by weight and not more than 1.5 parts by weight, relative to 100 parts by weight of the styrene resin. In a case where the amount of the alcohol is less than 0.2 parts by weight relative to 100 parts by weight of the styrene resin, the moldability improving effect by use of the alcohol cannot be expected much. On the other hand, in a case where the amount of the alcohol is more than 3.0 parts by weight relative to 100 parts by weight of the styrene resin, various characteristics, such as heat resistance, of the extruded foam may be deteriorated.

In one or more embodiments of the present invention, in order to (i) improve the moldability of the extruded foam, which moldability is deteriorated when the hydrofluoroolefin is used as the foaming agent, and (ii) impart suitable flame retardancy to the extruded foam, the hydrofluoroolefin and the alcohol need to be added at specific molar ratios, respectively, relative to 100 mol % in total of the hydrofluoroolefin and the alcohol. The mole ratio of the hydrofluoroolefin, relative to 100 mol % in total of the hydrofluoroolefin and the alcohol, may be not less than 65 mol % and not more than 90 mol %, not less than 65 mol % and not more than 85 mol %, or not less than 65 mol % and not more than 80 mol %. Meanwhile, the molar ratio of the alcohol, relative to 100 mol % in total of the hydrofluoroolefin and the alcohol, may be not less than 10 mol % and not more than 35 mol %, not less than 15 mol % and not more than 35 mol %, or not less than 20 mol % and not more than 35 mol %. In a case where (i) the molar ratio of the hydrofluoroolefin is less than 65 mol % and (ii) the molar ratio of the alcohol is more than 35 mol %, a proportion of the alcohol remaining in the extruded foam is too large. As a result, the flame retardancy of the extruded foam is deteriorated, so that a desired flame retardancy (described later) cannot be obtained. On the other hand, in a case where (i) the molar ratio of the hydrofluoroolefin is more than 90 mol % and (ii) the molar ratio of the alcohol added is less than 10 mol %, a surface property imparting effect and a thickness increasing effect are not sufficient.

The amount and/or the like of the hydrofluoroolefin to be added and the amount and/or the like of the alcohol to be added may be limited depending on various intended characteristics, such as a foaming ratio and the flame retardancy, of the foam. In a case where the amounts are outside respective desired ranges, the moldability of the extruded foam or the like may not be sufficient.

In one or more embodiments of the present invention, another foaming agent is further used. This makes it possible to bring about the plasticizing effect and/or an auxiliary foaming effect during the production of the foam. This ultimately allows a reduction in extrusion pressure and allows the foam to be stably produced.

Examples of the another foaming agent encompass (i) organic foaming agents such as: saturated hydrocarbons each having 3 to 5 carbon atoms, such as propane, n-butane, i-butane (hereinafter, also referred to as “isobutane”), n-pentane, i-pentane and neopentane; ethers such as dimethyl ether, diethyl ether, methyl ethyl ether, isopropyl ether, n-butyl ether, diisopropyl ether, furan, furfural, 2-methylfuran, tetrahydrofuran, and tetrahydropyran; ketones such as dimethyl ketone, methyl ethyl ketone, diethyl ketone, methyl-n-propyl ketone, methyl-n-butyl ketone, methyl-i-butyl ketone, methyl-n-amyl ketone, methyl-n-hexyl ketone, ethyl-n-propyl ketone, and ethyl-n-butyl ketone; carboxylic acid esters such as methyl formate, ethyl formate, propyl formate, butyl formate, amyl formate, methyl propionate, and ethyl propionate; and alkyl halides such as methyl chloride and ethyl chloride, (ii) inorganic foaming agents such as water and carbon dioxide, and (iii) chemical foaming agents such as an azo compound and tetrazole. Each of these foaming agents can be used solely as the another foaming agent. Alternatively, two or more of these foaming agents can be used in combination as the another foaming agent.

In one or more embodiments of the present invention, of the above another foaming agents, at least one selected from the group consisting of the saturated hydrocarbon having 3 to 5 carbon atoms, dimethyl ether, and alkyl chloride is used in view of an excellent foamability and an excellent moldability during the production of the extruded foam. Of the above saturated hydrocarbons each having 3 to 5 carbon atoms, propane, n-butane, i-butane, or a mixture thereof may be used in view of the foamability. Further, in view of a heat insulating property of the foam, n-butane, i-butane, or a mixture thereof may be used, and i-butane may also be used. In addition, among alkyl chlorides, methyl chloride or ethyl chloride may be used in view of balance between (i) the foamability and the moldability during the production of the extruded foam and (ii) the flame retardancy of the extruded foam to be obtained.

However, in a case where the saturated hydrocarbon having 3 to 5 carbon atoms is used in one or more embodiments of the present invention, the amount of the saturated hydrocarbon having 3 to 5 carbon atoms added to the extruded foam may be limited. This is because, in a case where the amount of the saturated hydrocarbon having 3 to 5 carbon atoms remaining in the extruded foam is too large, the flame retardancy of the extruded foam may be deteriorated. The saturated hydrocarbon having 3 to 5 carbon atoms may be added in an amount of not less than 1.0 part by weight and not more than 3.0 parts by weight, not less than 1.0 part by weight and not more than 2.5 parts by weight, or not less than 1.0 part by weight and not more than 2.0 parts by weight, relative to 100 parts by weight of the styrene resin.

In a case where the another foaming agent that is not the saturated hydrocarbon having 3 to 5 carbon atoms, dimethyl ether, or alkyl chloride is used in combination with the hydrofluoroolefin and the alcohol, diethyl ether, methyl ethyl ether, or the like may be used in view of the foamability and the moldability during the production of the extruded foam. Meanwhile, in such a case, in view of flammability of the foaming agent and the flame retardancy of the foam, water or carbon dioxide may be used. Of these foaming agents, water may also be used in view of cost.

In one or more embodiments of the present invention, the foaming agent may be added in an amount of 2 parts by weight to 20 parts by weight, or 2 parts by weight to 15 parts by weight, in total, relative to 100 parts by weight of the styrene resin. In a case where the amount of the foaming agent is less than 2 parts by weight, the foaming ratio is low and, accordingly, the resin foam may not have characteristics such as a lightweight property and the heat insulating property. In a case where the amount of the foaming agent is more than 20 parts by weight, a defect such as a void may occur in the foam because the amount of the foaming agent is excessively large.

In one or more embodiments of the present invention, in a case where water is used as the another foaming agent, a water absorbing substance may be added so that the extrusion foaming molding is stably carried out. Specific examples of the water absorbing substance used in one or more embodiments of the present invention encompass: water absorbing polymers such as a polyacrylate polymer, a starch-acrylic acid graft copolymer, a polyvinyl alcohol polymer, a vinyl alcohol-acrylate copolymer, an ethylene-vinyl alcohol copolymer, an acrylonitrile-methyl methacrylate-butadiene copolymer, a polyethylene oxide copolymer, and derivatives thereof; fine powders each having a hydroxyl group on a surface thereof and having a particle diameter of not more than 1000 nm, such as anhydrous silica (silicon oxide) having a silanol group on a surface thereof [AEROSIL, manufactured by Nippon AEROSIL CO., LTD, is, for example, commercially available]; water absorbing or water swelling layer silicates, such as smectite and water swelling fluorine mica, and products obtained by organification of such water absorbing or water swelling layer silicates; and porous substances such as zeolite, activated carbon, alumina, silica gel, porous glass, activated clay, diatomaceous earth, and bentonite. An amount of the water absorbing substance to be added is adjusted as appropriate depending on the amount and/or the like of the water to be added, but may be 0.01 parts by weight to 5 parts by weight, or 0.1 parts by weight to 3 parts by weight, relative to 100 parts by weight of the styrene resin.

In a method for producing a styrene resin extruded foam in accordance with one or more embodiments of the present invention, a pressure at which the foaming agent is added or injected is not limited in particular. The pressure only needs to be higher than an internal pressure of the extruder or the like.

(1-1-4. Flame Retarder)

In one or more embodiments of the present invention, it is possible to impart the flame retardancy to the styrene resin extruded foam, by causing the styrene resin extruded foam to contain a flame retarder in an amount of not less than 0.5 parts by weight and not more than 8.0 parts by weight relative to 100 parts by weight of the styrene resin. In a case where the amount of the flame retarder is less than 0.5 parts by weight, it tends to be difficult for the styrene resin extruded foam to achieve good characteristics such as the flame retardancy. In a case where the amount of the flame retarder is more than 8.0 parts by weight, the stability during the production of the foam, the surface property, or the like may be impaired. Note, however, that the amount of the flame retarder may be adjusted as appropriate, depending on the amount of the foaming agent to be added, the apparent density of the foam, a type or an amount of, for example, an additive having a flame retardance synergistic effect, and the like, so that, in a case where the flame retardancy is measured by the measurement method A specified in JIS A9521, the flame retardancy matches flame retardancy specified in JIS A9521.

As the flame retarder, a bromine flame retarder may be used. In one or more embodiments of the present invention, specific examples of the bromine flame retarder encompass aliphatic bromine containing polymers such as hexabromocyclododecane, tetrabromobisphenol A-bis(2,3-dibromo-2-methylpropyl)ether, tetrabromobisphenol A-bis(2,3-dibromopropyl)ether, tris(2,3-dibromopropyl)isocyanurate, and a brominated styrene-butadiene block copolymer. Each of these bromine flame retarders can be used solely. Alternatively, two or more of these bromine flame retarders can be used in combination.

Of these bromine flame retarders, a mixed bromine flame retarder made up of tetrabromobisphenol A-bis(2,3-dibromo-2-methylpropyl)ether and tetrabromobisphenol A-bis(2,3-dibromopropyl)ether, the brominated styrene-butadiene block copolymer, or hexabromocyclododecane may be used, because such bromine flame retarders, for example, (i) allow extrusion operation to be favorably carried out and (ii) do not adversely affect the heat resistance of the foam. Each of these substances can be used solely. Alternatively, some of these substances can be used as a mixture.

The styrene resin extruded foam in accordance with one or more embodiments of the present invention may contain the bromine flame retarder in an amount of not less than 0.5 parts by weight and not more than 5.0 parts by weight, not less than 1.0 part by weight and not more than 5.0 parts by weight, or not less than 1.5 parts by weight and not more than 5.0 parts by weight, relative to 100 parts by weight of the styrene resin. In a case where the amount of the bromine flame retarder is less than 0.5 parts by weight, it tends to be difficult for the styrene resin extruded foam to achieve good characteristics such as the flame retardancy. In a case where the amount of the bromine flame retarder is more than 5.0 parts by weight, the stability during the production of the foam, the surface property, or the like may be impaired.

In one or more embodiments of the present invention, it is possible to use, in combination with the flame retarder, a radical generating agent for the purpose of enhancement of the flame retardancy of the styrene resin extruded foam. Specific examples of the radical generating agent encompass 2,3-dimethyl-2,3-diphenylbutane, poly-1,4-diisopropylbenzene, 2,3-diethyl-2,3-diphenylbutane, 3,4-dimethyl-3,4-diphenylhexane, 3,4-diethyl-3,4-diphenylhexane, 2,4-diphenyl-4-methyl-1-pentene, and 2,4-diphenyl-4-ethyl-1-pentene. A peroxide such as dicumyl peroxide can be also used. Of these radical generating agents, a radical generating agent may be used which is stable at a temperature at which the resin is processed. Specifically, 2,3-dimethyl-2,3-diphenylbutane and poly-1,4-diisopropylbenzene may be used. The radical generating agent may be added in an amount of 0.05 parts by weight to 0.5 parts by weight relative to 100 parts by weight of the styrene resin.

Furthermore, for the purpose of enhancement of the flame retardancy, in other words, as an auxiliary flame retarder, a phosphorus flame retarder such as phosphoric ester and phosphine oxide can be used in combination with the flame retarder, provided that the phosphorus flame retarder does not impair thermal stability of the styrene resin extruded foam. Examples of the phosphoric ester include triphenyl phosphate, tris(tributylbromoneopentyl)phosphate, tricresyl phosphate, trixylenyl phosphate, cresyl diphenyl phosphate, 2-ethylhexyl diphenyl phosphate, trimethyl phosphate, triethyl phosphate, tributyl phosphate, tris(2-ethylhexyl)phosphate, tris(butoxyethyl)phosphate, and condensed phosphoric esters. In particular, triphenyl phosphate or tris(tributylbromoneopentyl)phosphate may be used. Of phosphine oxide type phosphorus flame retarders, triphenylphosphine oxide may be used. Each of these phosphoric esters and phosphine oxides can be used solely. Alternatively, two or more of these phosphoric esters and phosphine oxides can be used in combination. The phosphorus flame retarder may be added in an amount of 0.1 parts by weight to 2 parts by weight relative to 100 parts by weight of the styrene resin.

(1-1-5. Stabilizer)

In one or more embodiments of the present invention, a stabilizer which is a resin and/or a stabilizer which has flame retardancy can be used as necessary. Such a stabilizer is not limited in particular. Specific examples of the stabilizer encompass: (i) epoxy compounds such as a bisphenol A diglycidyl ether type epoxy resin, a cresol novolac type epoxy resin, and a phenol novolac type epoxy resin; (ii) polyhydric alcohol esters each of which (a) is a mixture of esters each having at least one hydroxyl group in its molecule and each being obtained by reacting a polyhydric alcohol (such as pentaerythritol, dipentaerythritol, or tripentaerythritol) and a monovalent carboxylic acid (such as acetic acid or propionic acid) or a divalent carboxylic acid (such as adipic acid or glutamic acid) and (b) may contain a raw material polyhydric alcohol in a small amount; (iii) phenolic stabilizers such as triethylene glycol-bis-3-(3-tert-butyl-4-hydroxy-5-methylphenyl)propionate, pentaerythritol tetrakis[3-(3′,5′-di-tert-butyl-4′-hydroxyphenyl)propionate], and octadecyl 3-(3,5-di-tert-butyl-4-hydroxyphenyl)propionate; (iv) phosphite stabilizers such as 3,9-bis(2,4-di-tert-butylphenoxy)-2,4,8,10-tetraoxa-3,9-diphosphaspiro [5.5] undecane, 3,9-bis(2,6-di-tert-butyl-4-methylphenoxy)-2,4,8,10-tetraoxa-3,9-diphosphaspiro [5.5] undecane, and tetrakis(2,4-di-tert-butyl-5-methylphenyl)-4,4′-biphenylene diphosphonite). These stabilizers may be used because these stabilizers do not decrease the flame retardancy of the foam and these stabilizers enhance the thermal stability of the foam.

(1-1-6. Heat Ray Radiation Inhibitor)

The styrene resin extruded foam in accordance with one or more embodiments of the present invention can contain graphite as a heat ray radiation inhibitor so that the heat insulating property is enhanced. Examples of the graphite used in one or more embodiments of the present invention encompass flake (scale-like) graphite, amorphous graphite, spheroidal graphite, and artificial graphite. Of these kinds of graphite, graphite which contains flake (scale-like) graphite as a main component may be used because such graphite brings about a greater heat ray radiation inhibiting effect. The graphite used in one or more embodiments of the present invention is one that may contain fixed carbon at a proportion of not less than 80%, or not less than 85%. The graphite which contains the fixed carbon at the above proportion allows the foam to have a high heat insulating property.

The graphite may have a dispersed particle diameter of not more than 15 μm, or not more than 10 μm. The graphite which has a dispersed particle diameter falling within the above range has a large specific surface area, so that a probability of collision between the graphite and a heat ray radiation is increased. This ultimately causes an increase in the heat ray radiation inhibiting effect. In order for the dispersed particle diameter to fall within the above range, it is only necessary to select the graphite which has a primary particle diameter of not more than 15 μm.

Note that the dispersed particle diameter indicates a number-based arithmetical mean of particle diameters of particles dispersed in a foam, and the particle diameters are measured while a cross section of the foam is magnified with use of a microscope or the like. Note that the primary particle diameter means a volume average particle diameter (d50).

In one or more embodiments of the present invention, the graphite may be contained in an amount of not less than 1.0 part by weight and not more than 5.0 parts by weight, or not less than 1.5 parts by weight and not more than 3.0 parts by weight, relative to 100 parts by weight of the styrene resin. In a case where the amount of the graphite is less than 1.0 part by weight, the graphite does not bring about a sufficient heat ray radiation inhibiting effect. In a case where the amount of the graphite is more than 5.0 parts by weight, the graphite does not bring about a heat ray radiation inhibiting effect equivalent to the amount and, therefore, there is no advantage in terms of a cost.

The heat ray radiation inhibitor indicates a substance which reflects, scatters, and absorbs light in a near infrared region or an infrared region (for example, wavelength region of approximately 800 nm to 3000 nm). The foam which contains the heat ray radiation inhibitor can have a high heat insulating property. As the heat ray radiation inhibitor which can be used in one or more embodiments of the present invention, white particles, such as titanium oxide, barium sulfate, zinc oxide, aluminum oxide, and antimony oxide, can be used in combination with the graphite. Each of these white particles can be used solely. Alternatively, two or more of these white particles can be used in combination. Of these white particles, titanium oxide or barium sulfate may be used, and titanium oxide may also be used, because such white particles bring about a greater heat ray radiation inhibiting effect. A dispersed particle diameter of the white particles is not limited in particular. For example, a dispersed particle diameter of titanium oxide may be 0.1 μm to 10 μm, or 0.15 μm to 5 μm, in view of effective reflection of an infrared ray and in view of coloring of the resin.

In one or more embodiments of the present invention, the white particles may be contained in an amount of not less than 1.0 part by weight and not more than 3.0 parts by weight, or not less than 1.5 parts by weight and not more than 2.5 parts by weight, relative to 100 parts by weight of the styrene resin. The white particles have a less heat ray radiation inhibiting effect than the graphite. Accordingly, in a case where the amount of the white particles is less than 1.0 part by weight, the white particles hardly bring about the heat ray radiation inhibiting effect even though the white particles are contained. In a case where the amount of the white particles is more than 3.0 parts by weight, the white particles do not bring about the heat ray radiation inhibiting effect equivalent to the amount, and, in the meanwhile, the flame retardancy of the foam tends to be deteriorated.

In one or more embodiments of the present invention, the heat ray radiation inhibitor may be contained in an amount of not less than 1.0 part by weight and not more than 6.0 parts by weight, or not less than 2.0 parts by weight and not more than 5.0 parts by weight, in total, relative to 100 parts by weight of the styrene resin. In a case where the amount of the heat ray radiation inhibitor is less than 1.0 part by weight in total, it is difficult to achieve the heat insulating property. Meanwhile, as an amount of a solid additive such as the heat ray radiation inhibitor is increased, the number of nucleating points is increased, so that the cells in the foam become fine or the resin itself becomes poor in stretch. This tends to make it difficult to (i) impart a beautiful surface to the extruded foam and (ii) increase the thickness of the extruded foam. In particular, in a case where the amount of the heat ray radiation inhibitor is more than 6.0 parts by weight in total, it tends to be difficult to (i) impart a beautiful surface to the extruded foam and (ii) increase the thickness of the extruded foam. Furthermore, in such a case, extrusion stability and the flame retardancy tends to be impaired.

(1-1-7. Additive)

In one or more embodiments of the present invention, an additive can be further contained in the styrene resin as necessary, provided that the additive does not inhibit effects in accordance with one or more embodiments of the present invention. Examples of the additive encompass: inorganic compounds such as silica, calcium silicate, wollastonite, kaolin, clay, mica, and calcium carbonate; processing aids such as sodium stearate, calcium stearate, magnesium stearate, barium stearate, liquid paraffin, olefin wax, and a stearyl amide compound; light-resistant stabilizers such as a phenolic antioxidant, a phosphorus stabilizer, a nitrogen stabilizer, a sulfuric stabilizer, benzotriazoles, and hindered amines; cell diameter adjusting agents such as talc; flame retarders other than the foregoing flame retarders; antistatic agents; coloring agents such as a pigment; and plasticizers.

Examples of a method or a procedure for adding such various additives to the styrene resin include: a method in which the various additives are added to the styrene resin and then the various additives and the styrene resin are mixed together by dry blending; a method in which the various additives are added to a molten styrene resin through a feeder provided in the middle of the extruder; a method in which (i) a masterbatch is prepared in advance by causing, with use of an extruder, a kneader, a Banbury mixer, a roll, or the like, the styrene resin to contain the various additives that are highly concentrated and (ii) the masterbatch and the styrene resin which is different from that contained in the masterbatch are mixed together by dry blending; and a method in which the various additives are supplied to the extruder through a feeding machine different from that used for the styrene resin. For example, a procedure is employed in which (i) the various additives are added to and mixed with the styrene resin, (ii) a resultant mixture is supplied to the extruder and heated so that the mixture is melted, and then (iii) the foaming agent is added to and mixed with the mixture. Note, however, that a timing at which the various additives or the foaming agent are/is added to the styrene resin and a time period during which the styrene resin is kneaded or the styrene resin and the various additives and/or the foaming agent are kneaded are not limited in particular.

(1-2. Physical Properties)

A thermal conductivity of the styrene resin extruded foam in accordance with one or more embodiments of the present invention is not limited in particular. In view of the heat insulating property enough to cause the styrene resin extruded foam to function, for example, as a heat insulating material for a building or as a heat insulating material for a cool box or a refrigerator car, the thermal conductivity which is measured 1 week after the production at an average temperature of 23° C. may be not more than 0.0285 W/mK, not more than 0.0245 W/mK, or not more than 0.0225 W/mK.

The styrene resin extruded foam in accordance with one or more embodiments of the present invention may have an apparent density of not less than 20 kg/m³ and not more than 45 kg/m³, or not less than 25 kg/m³ and not more than 40 kg/m³, in view of the heat insulating property enough to cause the styrene resin extruded foam to function, for example, as a heat insulating material for a building or as a heat insulating material for a cool box or a refrigerator car and in view of the lightweight property.

The styrene resin extruded foam in accordance with one or more embodiments of the present invention may have a closed cell ratio of not less than 90%, or not less than 95%. In a case where the closed cell ratio is less than 90%, the foaming agent dissipates from the extruded foam early. This causes a decrease in the heat insulating property.

The styrene resin extruded foam in accordance with one or more embodiments of the present invention may have an average cell diameter of not less than 0.05 mm and not more than 0.5 mm, not less than 0.05 mm and not more than 0.4 mm, or not less than 0.05 mm and not more than 0.3 mm, in a thickness direction of the styrene resin extruded foam. In general, as the average cell diameter becomes smaller, a distance between cell walls in the foam becomes shorter. Accordingly, since a range of movement of the cells in the extruded foam is narrow while the shape is being imparted to the extruded foam in the extrusion foaming, it is difficult to deform the cells. This tends to make it difficult to (i) impart a beautiful surface to the extruded foam and (ii) increase the thickness of the extruded foam. In particular, in a case where the average cell diameter of the styrene resin extruded foam is less than 0.05 mm in the thickness direction of the styrene resin extruded foam, it tends to be considerably difficult to (i) impart a beautiful surface to the extruded foam and (ii) increase the thickness of the extruded foam. In a case where the average cell diameter of the styrene resin extruded foam is more than 0.5 mm in the thickness direction of the styrene resin extruded foam, the styrene resin extruded foam may not achieve a sufficient heat insulating property.

Note that the average cell diameter of the styrene resin extruded foam in accordance with one or more embodiments of the present invention is measured as follows with use of a microscope [manufactured by KEYENCE, DIGITAL MICROSCOPE VHX-900].

Three portions of an obtained styrene resin extruded foam are observed under the microscope and photographs of the three portions are taken with use of the microscope at a magnification of 100 times. Note that the three portions include (i) a portion in the middle of the styrene resin extruded foam in a width direction of the styrene resin extruded foam, (ii) a portion which is located 150 mm apart from one edge of the styrene resin extruded foam toward the other edge of the styrene resin extruded foam in the width direction, and (iii) a portion which is located 150 mm apart from the other edge of the styrene resin extruded foam toward the one edge of the styrene resin extruded foam in the width direction. Specifically, a first cross section of a middle portion, in the thickness direction, of each of the three portions is observed and a photograph of the first cross section is taken in a direction in which the styrene resin extruded foam is extruded (hereinafter, referred to as an extrusion direction), and a second cross section of the middle portion, in the thickness direction, of each of the three portions is observed and a photograph of the second cross section is taken in the width direction. Note that the first cross section is a cross section in parallel to the width direction and the second cross section is a cross section perpendicular to the width direction. Then, three 2-millimeter straight lines are arbitrarily drawn in the thickness direction in each of such magnified photographs (three straight lines for each observed direction at each observed portion), and the number “a” of cells in contact with the three straight lines is counted. From the number “a” thus counted, an average cell diameter A in the thickness direction is calculated for each observed direction at each observed portion by the following Expression (3). An average of average cell diameters thus calculated for the three portions (two directions at each portion) is regarded as an average cell diameter A (average) in the thickness direction of the styrene resin extruded foam.

Average cell diameter A (mm) in a thickness direction at each observed portion=2×3/the number “a” of cells (3)

The three portions of the obtained styrene resin extruded foam are observed under the microscope and photographs of the three portions are taken with use of the microscope at a magnification of 100 times. Note that the three portions include (i) the portion in the middle of the styrene resin extruded foam in the width direction of the styrene resin extruded foam, (ii) the portion which is located 150 mm apart from the one edge of the styrene resin extruded foam toward the other edge of the styrene resin extruded foam in the width direction, and (iii) the portion which is located 150 mm apart from the other edge of the styrene resin extruded foam toward the one edge of the styrene resin extruded foam in the width direction. Specifically, a third cross section of the middle portion, in the thickness direction, of each of the three portions is observed and a photograph of the third cross section is taken in the width direction. Note that the third cross section is a cross section which is in parallel to the extrusion direction and which is perpendicular to the width direction. Then, three 2-millimeter straight lines are arbitrarily drawn in the extrusion direction in such a magnified photograph (three straight lines for each observed portion), and the number “b” of cells in contact with the three straight lines is counted. From the number “b” thus counted, an average cell diameter B in the extrusion direction is calculated for each observed portion by the following Expression (4). An average of average cell diameters thus calculated for the three portions is regarded as an average cell diameter B (average) in the extrusion direction of the styrene resin extruded foam.

Average cell diameter B (mm) in an extrusion direction at each observed portion=2×3/the number “b” of cells (4)

The three portions of the obtained styrene resin extruded foam are observed under the microscope and photographs of the three portions are taken with use of the microscope at a magnification of 100 times. Note that the three portions include (i) the portion in the middle of the styrene resin extruded foam in the width direction of the styrene resin extruded foam, (ii) the portion which is located 150 mm apart from the one edge of the styrene resin extruded foam toward the other edge of the styrene resin extruded foam in the width direction, and (iii) the portion which is located 150 mm apart from the other edge of the styrene resin extruded foam toward the one edge of the styrene resin extruded foam in the width direction. Specifically, a fourth cross section of the middle portion, in the thickness direction, of each of the three portions is observed and a photograph of the fourth cross section is taken in the extrusion direction. Note that the fourth cross section is a cross section which is in parallel to the width direction and which is perpendicular to the extrusion direction. Then, three 2-millimeter straight lines are arbitrarily drawn in the width direction in such a magnified photograph (three straight lines for each observed portion), and the number “c” of cells in contact with the three straight lines is counted. From the number “c” thus counted, an average cell diameter C in the width direction is calculated for each observed portion by the following Expression (5). An average of average cell diameters thus calculated for the three portions is regarded as an average cell diameter C (average) in the width direction of the styrene resin extruded foam.

Average cell diameter C (mm) in a width direction at each observed portion=2×3/the number “c” of cells (5)

The styrene resin extruded foam in accordance with one or more embodiments of the present invention may have a cell deformation ratio of not less than 0.7 and not more than 2.0, not less than 0.8 and not more than 1.5, or not less than 0.8 and not more than 1.2. In a case where the cell deformation ratio is less than 0.7, the styrene resin extruded foam has low compressive strength. Accordingly, it may not be possible for the extruded foam to secure strength suitable for a purpose. Furthermore, since the cells each attempt to return to a spherical shape, the extruded foam tends to be poor in maintaining dimensions (shape). In a case where the cell deformation ratio is more than 2.0, the number of cells in the thickness direction of the extruded foam is decreased. This reduces the heat insulating property enhancing effect which is brought about by a shape of each of the cells.

Note that the cell deformation ratio of the styrene resin extruded foam in accordance with one or more embodiments of the present invention can be calculated from the following Expression (6) with use of the foregoing average cell diameters.

Cell deformation ratio (no unit)=A (average)/{[B (average)+C (average)]/2} (6)

The styrene resin extruded foam in accordance with one or more embodiments of the present invention may have a thickness of not less than 10 mm and not more than 150 mm, not less than 20 mm and not more than 130 mm, or not less than 30 mm and not more than 120 mm, in view of (i) the heat insulating property enough to cause the styrene resin extruded foam to function, for example, as a heat insulating material for a building or as a heat insulating material for a cool box or a refrigerator car, (ii) the bending strength, and (iii) the compressive strength.

Note that, as described in Examples and Comparative Examples of one or more embodiments of the present invention, after impartation of the shape by the extrusion foaming molding, both surfaces of the styrene resin extruded foam, which both surfaces are plane surfaces each perpendicular to the thickness direction, may be each cut off at a depth of approximately 5 mm in the thickness direction so that the styrene resin extruded foam has a product thickness. However, the thickness of the styrene resin extruded foam in accordance with one or more embodiments of the present invention indicates a thickness of the styrene resin extruded foam whose both surfaces are not cut off after the impartation of the shape by the extrusion foaming molding, unless otherwise specified.

The styrene resin extruded foam in accordance with one or more embodiments of the present invention needs to have a plate shape without undulating in any of the extrusion direction, the width direction, and the thickness direction, so as to be suitably used as, for example, a heat insulating material for a building or as a heat insulating material for a cool box or a refrigerator car. As has been described, in a case where, for example, (i) the hydrofluoroolefin is used, (ii) the heat ray radiation inhibitor is used, or (iii) the average cell diameter of the styrene extruded foam is made fine, there may be the following disadvantages. That is, in such a case, the resin itself becomes poor in stretch or it becomes difficult to deform the cells because the range of the movement of the cells in the extruded foam is narrow during the impartation of the shape by the extrusion foaming. As a result, in a case where it is intended that the thickness of the styrene resin extruded foam is adjusted by the extrusion foaming molding, it is not possible to impart the shape to the styrene resin extruded foam, so that the extruded foam may undulate in at least one of the extrusion direction, the width direction, and the thickness direction of the extruded foam and may consequently not have a plate shape.

The surface property of the styrene resin extruded foam in accordance with one or more embodiments of the present invention is particularly important so that the stability is secured during the production. Furthermore, the surface property of the styrene resin extruded foam in accordance with one or more embodiments of the present invention is particularly important, in a case where the styrene resin extruded foam is used, as it is, as a product without cutting of the both surfaces of the styrene resin extruded foam, which both surfaces are plane surfaces each perpendicular to the thickness direction. Therefore, the styrene resin extruded foam needs to have a beautiful surface without having a flow mark, a crack, a partial peeling, or the like. As has been described, in a case where, for example, (i) the hydrofluoroolefin is used, (ii) the heat ray radiation inhibitor is used, or (iii) the average cell diameter of the styrene extruded foam is made fine, there may be the following disadvantages. That is, in such a case, the resin itself becomes poor in stretch or it becomes difficult to deform the cells because the range of the movement of the cells in the extruded foam is narrow during the impartation of the shape by the extrusion foaming. As a result, a flow mark, a crack, a partial peeling, or the like may occur on the surface of the extruded foam, and the surface property of the extruded foam may be impaired. A flow mark indicates a trace of a flow of the molten resin, and occurs on the both surfaces of the extruded foam, which both surfaces are plane surfaces each perpendicular to the thickness direction, in a case where, for example, the resin itself is rigid and poor in stretch. A crack occurs in a case where, for example, an excessive force is applied to the extruded foam, and is particularly likely to occur in a case where, for example, it is intended that the extruded foam is forcedly molded and the thickness of the extruded foam is increased in a state where the thickness of the extruded foam is not easily increased. A crack may occur on the both surfaces of the extruded foam, which both surfaces are plane surfaces each perpendicular to the thickness direction, or may occur on an edge (side portion), in the width direction, of the extruded foam. In a worst-case scenario, the extruded foam being continuously produced may be torn off from a crack. A partial peeling may occur, in part or in whole, on the both surfaces of the extruded foam, which both surfaces are plane surfaces each perpendicular to the thickness direction, and/or the edge (side portion), in the width direction, of the extruded foam, in a case where, for example, a portion of the molten resin having been foamed is excessively solidified and, consequently, such a portion is stuck in a mold and turned up.

According to one or more embodiments of the present invention, it is thus possible to easily obtain a styrene resin extruded foam which has an excellent heat insulating property, an excellent flame retardancy, a beautiful appearance, and a sufficient thickness suitable for use.

[2. Method for Producing Styrene Resin Extruded Foam]

A method for producing a styrene resin extruded foam in accordance with one or more embodiments of the present invention is a production method used to produce a styrene resin extruded foam described in the above [1. Styrene resin extruded foam]. Out of arrangements used in the method for producing a styrene resin extruded foam in accordance with one or more embodiments of the present invention, arrangements which have been already described in the above [1. Styrene resin extruded foam] will not be described here.

According to the method for producing a styrene resin extruded foam in accordance with one or more embodiments of the present invention, a styrene resin, and as necessary, a flame retarder, a stabilizer, a heat ray radiation inhibitor, any other additive and/or the like are supplied to a heat-melting section of an extruder or the like. In so doing, it is possible to add, to the styrene resin, the hydrofluoroolefin, the alcohol, and at least one selected from the group consisting of the saturated hydrocarbon having 3 to 5 carbon atoms, the dimethyl ether and the alkyl chloride, and as necessary, the another foaming agent additionally, under a high pressure condition at any stage. Then, a foam is produced by (i) causing a mixture of (a) the styrene resin, (b) the hydrofluoroolefin, (c) the alcohol, and (d) the at least one selected from the group consisting of the saturated hydrocarbon having 3 to 5 carbon atoms, the dimethyl ether, and the alkyl chloride, and (e) any other additive(s) and/or the another foaming agent, to be a fluid gel (in other words, a molten resin) (ii) cooling the fluid gel to a temperature suitable for extrusion foaming, and then (iii) extruding the fluid gel thus cooled to a low pressure region through a die so that the fluid gel is foamed.

A heating temperature, at which the mixture is heated in the heat-melting section so that the mixture is melted, only needs to be equal to or higher than a temperature at which the styrene resin melts. However, the heating temperature may be a temperature at which degradation of molecules of the resin, which degradation is caused by an effect of an additive or the like, is prevented as much as possible, and may be, for example, 150° C. to 260° C. A time period during which the mixture is melted and kneaded in the heat-melting section cannot be uniquely specified, because the time period varies depending on an amount of the styrene resin extruded per unit time and/or a type of the extruder used as the heat-melting section and as a melting and kneading section. The time period is set as appropriate to a time period necessary for the styrene resin, the foaming agent, and the additive to be uniformly dispersed and mixed together.

Examples of the melting and kneading section include a screw extruder. However, the melting and kneading section is not limited in particular, provided that the melting and kneading section is one that is used for usual extrusion foaming.

As a foaming molding method in accordance with one or more embodiments of the present invention, the following method is, for example, employed. That is, an extruded foam is obtained by releasing the fluid gel from a high pressure region to the low pressure region through a slit die whose opening, which is used for extrusion molding, has a linear slit shape. The extruded foam is then molded into a plate-shaped foam, having a large cross-sectional area, with use of, for example, (i) a mold attached to or provided so as to be in contact with the slit die and (ii) a forming roll provided on a downstream side of the mold so as to be adjacent to the mold. By (i) adjusting a shape of a surface of the mold on which surface the extruded foam flows and (ii) adjusting a temperature of the mold, the foam is caused to achieve a desired cross-sectional shape, a desired surface property, and a desired quality.

The present invention is not limited to any of the foregoing embodiments, but can be altered by a skilled person in the art within the scope of the claims. The present invention also encompasses, in its technical scope, any embodiment derived by combining technical means disclosed in differing embodiments. Furthermore, a new technical feature can be formed by combining technical means disclosed in differing embodiments.

The method for producing a styrene resin extruded foam in accordance with one or more embodiments of the present invention can be arranged as follows.

[1] A method for producing a styrene resin extruded foam including the step of foaming a styrene resin composition containing: not less than 0.5 parts by weight and not more than 8.0 parts by weight of a flame retarder relative to 100 parts by weight of a styrene resin; not less than 65 mol % and not more than 90 mol % of a hydrofluoroolefin and not less than 10 mol % and not more than 35 mol % of an alcohol, relative to 100 mol % in total of the hydrofluoroolefin and the alcohol; and at least one selected from the group consisting of a saturated hydrocarbon having 3 to 5 carbon atoms, dimethyl ether, and alkyl chloride, the styrene resin extruded foam having an apparent density of not less than 20 kg/m³ and not more than 45 kg/m³ and a closed cell ratio of not less than 90%.

[2] The method for producing a styrene resin extruded foam as set forth in [1], wherein the hydrofluoroolefin is added in an amount of not less than 3.0 parts by weight and not more than 14.0 parts by weight relative to 100 parts by weight of the styrene resin.

[3] The method for producing a styrene resin extruded foam as set forth in [1] or [2], wherein the styrene resin composition further contains not less than 1.0 part by weight and not more than 5.0 parts by weight of graphite relative to 100 parts by weight of the styrene resin.

[4] The method for producing a styrene resin extruded foam as set forth in any one of [1] to [3], wherein the alcohol is at least one selected from the group consisting of ethanol, propyl alcohol, and i-propyl alcohol.

[5] The method for producing a styrene resin extruded foam as set forth in any one of [1] to [4], wherein the saturated hydrocarbon having 3 to 5 carbon atoms is added in an amount of not less than 1.0 part by weight and not more than 3.0 parts by weight, relative to 100 parts by weight of the styrene resin.

[6] The method for producing a styrene resin extruded foam as set forth in any one of [1] to [5], wherein the hydrofluoroolefin is a tetrafluoropropene.

[7] The method for producing a styrene resin extruded foam as set forth in any one of [1] to [6], wherein the styrene resin extruded foam has a thickness of not less than 10 mm and not more than 150 mm.

[8] The method for producing a styrene resin extruded foam as set forth in any one of [1] to [7], wherein the flame retarder is a bromine flame retarder and contained in an amount of not less than 0.5 parts by weight and not more than 5.0 parts by weight relative to 100 parts by weight of the styrene resin.

The styrene resin extruded foam in accordance with one or more embodiments of the present invention can be arranged as follows.

[1] A styrene resin extruded foam including: not less than 0.5 parts by weight and not more than 8.0 parts by weight of a flame retarder relative to 100 parts by weight of a styrene resin; a hydrofluoroolefin; an alcohol; and at least one selected from the group consisting of a saturated hydrocarbon having 3 to 5 carbon atoms, dimethyl ether, and alkyl chloride, the styrene resin extruded foam having an apparent density of not less than 20 kg/m³ and not more than 45 kg/m³ and a closed cell ratio of not less than 90%, an amount of the hydrofluoroolefin added being not less than 65 mol % and not more than 90 mol %, relative to 100 mol % in total of the hydrofluoroolefin and the alcohol which are added, and an amount of the alcohol added being not less than 10 mol % and not more than 35 mol %, relative to 100 mol % in total of the hydrofluoroolefin and the alcohol which are added.

[2] The styrene resin extruded foam as set forth in [1], wherein an amount of the hydrofluoroolefin added to 100 parts by weight of the styrene resin is not less than 3.0 parts by weight and not more than 14.0 parts by weight.

[3] The styrene resin extruded foam as set forth in [1] or [2], further comprising not less than 1.0 part by weight and not more than 5.0 parts by weight of graphite relative to 100 parts by weight of the styrene resin.

[4] The styrene resin extruded foam as set forth in any one of [1] to [3], wherein the alcohol is at least one selected from the group consisting of ethanol, propyl alcohol, and i-propyl alcohol.

[5] The styrene resin extruded foam as set forth in any one of [1] to [4], wherein an amount of the saturated hydrocarbon having 3 to 5 carbon atoms added to 100 parts by weight of the styrene resin is not less than 1.0 part by weight and not more than 3.0 parts by weight.

[6] The styrene resin extruded foam as set forth in any one of [1] to [5], wherein the hydrofluoroolefin is a tetrafluoropropene.

[7] The styrene resin extruded foam as set forth in any one of [1] to [6], having a thickness of not less than 10 mm and not more than 150 mm.

[8] The styrene resin extruded foam as set forth in any one of [1] to [7], wherein the flame retarder is a bromine flame retarder and contained in an amount of not less than 0.5 parts by weight and not more than 5.0 parts by weight relative to 100 parts by weight of the styrene resin.

[9] A method for producing a styrene resin extruded foam as recited in any one of [1] to [8].

### EXAMPLES

The following description will discuss Examples of one or more embodiments of the present invention. Note that the present invention is obviously not limited to Examples below.

Raw materials used in Examples and Comparative Examples are as follows.

Base Resin

Styrene resin A [produced by PS Japan Corporation, G9401; MFR 2.2 g/10 minutes]

Styrene resin B [produced by PS Japan Corporation, 680; MFR 7.0 g/10 minutes]

Heat Ray Radiation Inhibitor

Graphite [produced by MARUTOYO Co., Ltd., M-885; flake (scale-like) graphite, primary particle diameter 5.5 μm, fixed carbon content 89%]

Titanium oxide [produced by Sakai Chemical Industry Co., Ltd., R-7E; primary particle diameter 0.23 μm]

Flame Retarder

Mixed bromine flame retarder [produced by Daiichi Kogyo Seiyaku Co., Ltd., GR-125P] made up of tetrabromobisphenol A-bis(2,3-dibromo-2-methylpropyl)ether and tetrabromobisphenol A-bis(2,3-dibromopropyl)ether

Brominated styrene-butadiene block polymer [produced by Chemtula, EMERALD INNOVATION #3000]

Auxiliary Flame Retarder

Triphenylphosphine oxide [SUMITOMO SHOJI CHEMICALS CO., LTD.]

Radical Generating Agent

Poly-1,4-diisopropylbenzene [produced by UNITED INITIATORS, CCPIB]

Stabilizer

Bisphenol-A-glycidyl ether [produced by ADEKA Corporation, EP-13]

Cresol novolac type epoxy resin [produced by HUNTSMAN Japan, ECN-1280]

Dipentaerythritol-adipic acid reaction mixture [produced by Ajinomoto Fine-Techno Co., Inc., PLENLIZER ST210]

Pentaerythritol tetrakis[3-(3′,5′-di-tert-butyl-4′-hydroxyphenyl)propionate] [produced by Chemtula, ANOX20]

3,9-bis(2,4-di-tert-butylphenoxy)-2,4,8,10-tetraoxa-3,9-diphosphaspiro [5.5] undecane [produced by Chemtula, Ultranox 626]

Triethylene glycol-bis-3-(3-tert-butyl-4-hydroxy-5-methylphenyl)propionate [produced by Songwon Japan K.K., SONGNOX 2450FF]

Other Additives

Talc [produced by Hayashi-Kasei Co., Ltd., Talcan Powder PK-Z]

Calcium stearate [produced by Sakai Chemical Industry Co., Ltd., SC-P]

Bentonite [produced by HOJUN Co., Ltd., BEN-GEL BLITE K11]

Silica [produced by Evonik Degussa Japan Co., Ltd., Carplex BS-304F]

Amide ethylene-bis-stearate [produced by Nichiyu Corporation, ALFLOW H-50S]

Foaming Agent

HFO-1234ze [produced by Honeywell Japan]

Dimethyl ether [produced by Iwatani Corporation]

Isobutane [produced by Mitsui Chemicals, Inc.]

Ethyl chloride [produced by Nihon Tokushu Kagaku Kogyo K.K.]

Ethanol [produced by Wako Pure Chemical Industries, Ltd., Ethanol of special grade chemical]

i-propyl alcohol [produced by Wako Pure Chemical Industries, Ltd., isopropanol of special grade chemical]

Water [tap water in Settsu City, Osaka]

In each of Examples and Comparative Examples, a styrene resin extruded foam was evaluated in terms of a thickness (before cutting), an apparent density, a closed cell ratio, an average cell diameter, a cell deformation ratio, an amount of HFO-1234ze remaining in 100 g of a styrene resin contained in the extruded foam, a thermal conductivity, a JIS flammability, and an appearance, in accordance with the following methods.

(1) Thickness of Styrene Resin Extruded Foam (Before Cutting)

Thicknesses of three portions of the styrene resin extruded foam were measured with use of a caliper [manufactured by Mitutoyo Corporation, M-type standard caliper N30]. The three portions included (i) a portion in the middle of the styrene resin extruded foam in a width direction of the styrene resin extruded foam, (ii) a portion which was located 150 mm apart from one edge of the styrene resin extruded foam toward the other edge of the styrene resin extruded foam in the width direction, and (iii) a portion which was located 150 mm apart from the other edge of the styrene resin extruded foam toward the one edge of the styrene resin extruded foam in the width direction. An average of the thicknesses of the three portions was regarded as a thickness of the styrene resin extruded foam.

(2) Apparent Density (Kg/m³)

A weight, a length, a width, and the thickness of an obtained styrene resin extruded foam were measured.

From the weight, the length, the width, and the thickness thus measured, a density of the foam was calculated based on the following Expression (7). A unit was converted into kg/m³.

Apparent density (g/cm³)=a weight (g) of a foam/a volume (cm³) of the foam (7)

(3) Closed Cell Ratio

Test pieces each having a thickness of 40 mm, a length (extrusion direction) of 25 mm, and a width of 25 mm were cut off from three portions of the obtained styrene resin extruded foam. The three portions included (i) a portion in the middle of the styrene resin extruded foam in the width direction, (ii) a portion which was located 150 mm apart from the one edge of the styrene resin extruded foam toward the other edge of the styrene resin extruded foam in the width direction, and (iii) a portion which was located 150 mm apart from the other edge of the styrene resin extruded foam toward the one edge of the styrene resin extruded foam in the width direction. Subsequently, closed cell ratios of the test pieces were each measured in accordance with Procedure C of ASTM-D2856-70, and each calculated based on the following Expression (8). An average of the closed cell ratios of the test pieces (that is, the three portions) was regarded as a closed cell ratio of the styrene resin extruded foam.

Closed cell ratio (%)=(V1−W/ρ)×100/(V2−W/ρ) (8)

wherein: V1 (cm³) represents a true volume (excluding a volume of cells other than closed cells) of a test piece which true volume is measured with use of an air comparison pycnometer [manufactured by TOKYO SCIENCE., model 1000]; V2 (cm³) represents an apparent volume of the test piece which apparent volume is calculated from external dimensions of the test piece that are measured with use of a caliper [manufactured by Mitutoyo Corporation, M-type standard caliper N30]; W (g) represents a total weight of the test piece; and ρ (g/cm³) represents a density of a styrene resin constituting an extruded foam and is set to 1.05 (g/cm³).

(4) Average Cell Diameter and Cell Deformation Ratio in Thickness Direction

An average cell diameter and a cell deformation ratio of the obtained styrene resin extruded foam were evaluated as described above.

(5) Amount of HFO-1234Ze Remaining in 100 g of Styrene Resin Contained in Extruded Foam

The obtained styrene resin extruded foam was left to stand still under the third-grade standard temperature condition (23° C.±5° C.) and the third-grade standard humidity condition (50^{+20, -10}% R.H.) each specified in JIS K 7100. Amounts of HFO-1234ze remaining immediately after production (within 2 hours after the production) and 1 week after the production were evaluated by the following method with use of the following apparatuses.

a) Apparatus; gas chromatograph GC-2014 [manufactured by Shimadzu Corporation]
b) Column; G-Column G-950 25UM [manufactured by Chemicals Evaluation and Research Institute, Japan]
c) Measurement conditions;

Injection port temperature: 65° C.

Column temperature: 80° C.

Detector temperature: 100° C.

Carrier gas: high-purity helium

Carrier gas flow rate: 30 mL/minute

Detector: TCD

Electric current: 120 mA

A test piece having a weight of approximately 1.2 g was cut off from the foam. Note that the weight varies depending on an apparent density of the test piece. The test piece was put in a closable glass vessel (hereinafter, referred to as a “closed vessel”) having a capacity of approximately 130 cc. Air in the closed vessel was removed with use of a vacuum pump. Subsequently, the closed vessel was heated at 170° C. for 10 minutes so that a foaming agent in the foam was taken out into the closed vessel. After a temperature of the closed vessel returned to an ordinary temperature, helium was introduced into the closed vessel so that a pressure inside the closed vessel returned to an atmospheric pressure. Thereafter, 40 μL of a mixed gas containing the HFO-1234ze was taken out with use of a microsyringe, and was evaluated with use of the above apparatuses a) and b) under the above conditions c).

(6) Thermal Conductivity

A test piece having a product thickness, a length (extrusion direction) of 300 mm, and a width of 300 mm was cut off from the styrene resin extruded foam. A thermal conductivity of the test piece was measured with use of a thermal conductivity measuring device [manufactured by EKO Instrument, HC-074] at an average temperature of 23° C. in accordance with JIS A 9521. Note that, after the styrene resin extruded foam was produced, (i) the test piece having the above dimensions was cut off from the styrene resin extruded foam, (ii) the test piece was left to stand still under the third-grade standard temperature condition (23° C.±5° C.) and the third-grade standard humidity condition (50^{+20, -10}% R.H.) each specified in JIS K 7100, and then (iii) the above measurement was carried out 1 week after the production.

(7) JIS Flammability

A test piece having a thickness of 10 mm, a length of 200 mm, and a width of 25 mm was cut off from the styrene resin extruded foam. A JIS flammability of the test piece was evaluated by the following criteria in accordance with JIS A 9521. Note that, after the styrene resin extruded foam was produced, (i) the test piece having the above dimensions was cut off from the styrene resin extruded foam, (ii) the test piece was left to stand still under the third-grade standard temperature condition (23° C.±5° C.) and the third-grade standard humidity condition (50^{+20, -10}% R.H.) each specified in JIS K 7100, and then (iii) the above measurement was carried out 1 week after the production.

Good: the test piece satisfied the following criterion: flame went out within three seconds, there was no afterglow, and the test piece did not burn beyond a burning limit indication line.
Poor: the test piece did not satisfy the above criterion.

(8) Appearance of Foam

An appearance of the foam was determined by the following criteria on the basis of results of evaluating a shape and a surface property of the foam as in (8)-1 and (8)-2.

Accepted: both of the shape and the surface property were evaluated as “Good.”
Rejected: at least one of the shape and the surface property was evaluated as “Unsatisfactory” or “Poor.”

(8)-1. Shape

The extruded foam which had been subjected to a forming roll but had not been cut was visually observed and evaluated by the following criteria.

Good: the extruded foam had a plate shape without undulating in any of the extrusion direction, the width direction, and the thickness direction of the extruded foam.
Poor: the extruded foam did not have a plate shape, and undulated in at least one of the extrusion direction, the width direction, and the thickness direction of the extruded foam.

(8)-2. Surface Property

Before and after being cut, the extruded foam was visually observed and evaluated by the following criteria. Note that a surface indicates a surface perpendicular to the thickness direction. Note also that “after being cut” indicates a state where both surfaces of the styrene resin extruded foam were each cut off at a depth of 5 mm in the thickness direction on the basis of the thickness (average of the thicknesses of the three portions) of the styrene resin extruded foam.

Good: the styrene resin extruded foam had beautiful surfaces without having a defect such as a flow mark, a crack, or a partial peeling.
Unsatisfactory: the styrene resin extruded foam had a defect, such as a flow mark, a crack, or a partial peeling, on its surface(s), but had no trace of such a defect on its surface(s) after being cut.
Poor: the styrene resin extruded foam had a defect, such as a flow mark, a crack, or a partial peeling, on its surface(s), and even had a trace of such a defect on its surface(s) after being cut.

In Examples and Comparative Examples, graphite and titanium oxide were each added in a form of a masterbatch prepared by the following method.

[Preparation of Graphite Masterbatch A]

Into a Banbury mixer, 100 parts by weight of a styrene resin A [produced by PS Japan Corporation, G9401], serving as a base resin, was introduced. Furthermore, 102 parts by weight of graphite [produced by MARUTOYO Co., Ltd., M-885] and 2.0 parts by weight of amide ethylene-bis-stearate [produced by Nichiyu Corporation, ALFLOW H-50S], relative to 100 parts by weight of the styrene resin A, were introduced into the Banbury mixer. Those materials were melted and kneaded for 20 minutes under a load of 5 kgf/cm² without being heated and cooled. At that time, a temperature of the resin was 190° C. The resin thus obtained was supplied to an extruder, and was extruded at a discharge quantity of 250 kg/hr through a die, which was attached to an end of the extruder and had a small hole, to obtain a strand-shaped resin. The strand-shaped resin was cooled and solidified in a water tank at 30° C. The strand-shaped resin was then cut to obtain a masterbatch.

[Preparation of Graphite Masterbatch B]

Into a Banbury mixer, 100 parts by weight of a styrene resin B [produced by PS Japan Corporation, 680], serving as a base resin, was introduced. Furthermore, 102 parts by weight of graphite [produced by MARUTOYO Co., Ltd., M-885] and 2.0 parts by weight of amide ethylene-bis-stearate [produced by Nichiyu Corporation, ALFLOW H-50S], relative to 100 parts by weight of the styrene resin B, were introduced into the Banbury mixer. Those materials were melted and kneaded for 20 minutes under a load of 5 kgf/cm² without being heated and cooled. At that time, a temperature of the resin was 180° C. The resin thus obtained was supplied to an extruder, and was extruded at a discharge quantity of 250 kg/hr through a die, which was attached to an end of the extruder and had a small hole, to obtain a strand-shaped resin. The strand-shaped resin was cooled and solidified in a water tank at 30° C. The strand-shaped resin was then cut to obtain a masterbatch.

[Preparation of Titanium Oxide Masterbatch A]

Into a Banbury mixer, 100 parts by weight of a styrene resin A [produced by PS Japan Corporation, G9401], serving as a base resin, was introduced. Furthermore, 154 parts by weight of titanium oxide [produced by Sakai Chemical Industry Co., Ltd., R-7E] and 2.6 parts by weight of amide ethylene-bis-stearate [produced by Nichiyu Corporation, ALFLOW H-50S], relative to 100 parts by weight of the styrene resin A, were introduced into the Banbury mixer. Those materials were melted and kneaded for 20 minutes under a load of 5 kgf/cm² without being heated and cooled. At that time, a temperature of the resin was 190° C. The resin thus obtained was supplied to an extruder, and was extruded at a discharge quantity of 250 kg/hr through a die, which was attached to an end of the extruder and had a small hole, to obtain a strand-shaped resin. The strand-shaped resin was cooled and solidified in a water tank at 30° C. The strand-shaped resin was then cut to obtain a masterbatch.

[Preparation of Titanium Oxide Masterbatch B]

Into a Banbury mixer, 100 parts by weight of a styrene resin B [produced by PS Japan Corporation, 680], serving as a base resin, was introduced. Furthermore, 154 parts by weight of titanium oxide [produced by Sakai Chemical Industry Co., Ltd., R-7E] and 2.6 parts by weight of amide ethylene-bis-stearate [produced by Nichiyu Corporation, ALFLOW H-50S], relative to 100 parts by weight of the styrene resin B, were introduced into the Banbury mixer. Those materials were melted and kneaded for 20 minutes under a load of 5 kgf/cm² without being heated and cooled. At that time, a temperature of the resin was 180° C. The resin thus obtained was supplied to an extruder, and was extruded at a discharge quantity of 250 kg/hr through a die, which was attached to an end of the extruder and had a small hole, to obtain a strand-shaped resin. The strand-shaped resin was cooled and solidified in a water tank at 30° C. The strand-shaped resin was then cut to obtain a masterbatch.

### Example 1

[Preparation of Resin Mixture]

Dry-blended were (i) 100 parts by weight of the styrene resin A [produced by PS Japan Corporation, G9401] serving as a base resin, and (ii) 3.0 parts by weight of the mixed bromine flame retarder [produced by Daiichi Kogyo Seiyaku Co., Ltd., GR-125P] made up of tetrabromobisphenol A-bis(2,3-dibromo-2-methylpropyl)ether and tetrabromobisphenol A-bis(2,3-dibromopropyl)ether and serving as a flame retarder, 1.0 part by weight of the triphenylphosphine oxide [SUMITOMO SHOJI CHEMICALS CO., LTD.] serving as an auxiliary flame retarder, 0.50 parts by weight of the talc [produced by Hayashi-Kasei Co., Ltd., Talcan Powder PK-Z] serving as a cell diameter adjusting agent, 0.20 parts by weight of the bisphenol-A-glycidyl ether [produced by ADEKA Corporation, EP-13] serving as a stabilizer, 0.20 parts by weight of the triethylene glycol-bis-3-(3-t-butyl-4-hydroxy-5-methylphenyl)propionate [produced by Songwon Japan K.K., SONGNOX 2450FF] serving as a stabilizer, 0.10 parts by weight of the dipentaerythritol-adipic acid reaction mixture [produced by Ajinomoto Fine-Techno Co., Inc., PLENLIZER ST210] serving as a stabilizer, 0.20 parts by weight of the calcium stearate [produced by Sakai Chemical Industry Co., Ltd., SC-P] serving as a lubricant, 0.40 parts by weight of the bentonite [produced by HOJUN Co., Ltd., BEN-GEL BLITE K11] serving as a water absorbing medium, and 0.40 parts by weight of the silica [produced by Evonik Degussa Japan Co., Ltd., Carplex BS-304F] serving as a water absorbing medium, relative to 100 parts by weight of the styrene resin A.

[Preparation of Extruded Foam]

A resin mixture thus obtained was supplied, at approximately 950 kg/hr, to an extruder which was made up of a single screw extruder (first extruder) having a screw diameter of 150 mm, a single screw extruder (second extruder) having a screw diameter of 200 mm, and a cooling device that were connected in series.

The resin mixture supplied to the first extruder was (i) heated to a resin temperature of 240° C. so that the resin mixture was melted or plasticized and (ii) kneaded. Subsequently, a foaming agent (2.5 parts by weight of the HFO-1234ze, 1.6 parts by weight of the isobutane, 4.0 parts by weight of the dimethyl ether, and 0.5 parts by weight of the ethanol, relative to 100 parts by weight of the base resin) was injected into the resin mixture in a vicinity of an end of the first extruder. Thereafter, the resin mixture was cooled to a resin temperature of 121° C. in the second extruder, which was connected to the first extruder, and the cooling device, and then extruded to an atmosphere through a nozzle (slit die), which was provided to an end of the cooling device and which had a rectangular cross section having a thickness of 6 mm and a width of 400 mm, at a foaming pressure of 3.0 MPa so that the resin mixture was foamed. Then, with use of a mold attached to the nozzle and a forming roll provided on a downstream side of the mold, an extruded foam plate was obtained which had a cross section having a thickness of 60 mm and a width of 1000 mm. The extruded foam plate was then cut with use of a cutter so as to have a thickness of 50 mm, a width of 910 mm, and length of 1820 mm. Table 1 shows results of evaluating an obtained foam.

### Examples 2 Through 18

Extruded foams were obtained as in Example 1, except that a type(s) of a material(s), an amount(s) of a material(s) added, and/or a production condition(s) was/were changed as in Tables 1 and 2. Tables 1 and 2 show physical properties of obtained extruded foams. Note that each of the graphite and the titanium oxide was prepared as a form of a masterbatch of a styrene resin in advance as described above, and was introduced during production of a resin mixture. In a case where the masterbatch was used, 100 parts by weight of a base resin was defined as a total amount of the base resin including the base resin contained in the masterbatch.

### Comparative Examples 1 Through 6

Extruded foams were obtained as in Example 1, except that a type(s) of a material(s), an amount(s) of a material(s) added, and/or a production condition(s) was/were changed as in Table 3. Table 3 shows physical properties of obtained extruded foams. Note that each of the graphite and the titanium oxide was prepared as a form of a masterbatch of a styrene resin in advance as described above, and was introduced during production of a resin mixture. In a case where the masterbatch was used, 100 parts by weight of a base resin was defined as a total amount of the base resin including the base resin contained in the masterbatch.

TABLE 1

| | | | | | Example 1 | Example 2 | Example 3 | Example 4 | Example 5 | Example 6 |
|---|---|---|---|---|---|---|---|---|---|---|
| Mixed | Base resin | Styrene resin A G9401 | | pts. wt. | 100 | 100 | 100 | 100 | 100 | 100 |
| materials | Heat ray radiation inhibitor | Graphite masterbach A | | pts. wt. | 0 | 0 | 0 | 0 | 0 | 0 |
| | masterbach | Graphite masterbach B | | pts. wt. | 0 | 0 | 0 | 0 | 0 | 0 |
| | | Titanium oxide | | pts. wt. | 0 | 0 | 0 | 0 | 0 | 0 |
| | | masterbach A | | | | | | | | |
| | | Titanium oxide | | pts. wt. | 0 | 0 | 0 | 0 | 0 | 0 |
| | | masterbach B | | | | | | | | |
| | Flame retarder | GR-125P | | pts. wt. | 3.0 | 3.0 | 3.0 | 3.0 | 3.0 | 3.0 |
| | | EMERALD | | pts. wt. | 0 | 0 | 0 | 0 | 0 | 0 |
| | | INNOVATION #3000 | | | | | | | | |
| | Auxiliary flame retarder | Triphenylphosphine | | pts. wt. | 1.0 | 1.0 | 1.0 | 1.0 | 1.0 | 1.0 |
| | | oxide | | | | | | | | |
| | Radical generating agent | CCPID | | pts. wt. | 0 | 0 | 0 | 0 | 0 | 0 |
| | Cell diameter adjusting | Talc | | pts. wt. | 0.50 | 0.50 | 0.50 | 0.50 | 0.50 | 0.50 |
| | agent | | | | | | | | | |
| | Stabilizerer | EP-13 | | pts. wt. | 0.20 | 0.20 | 0.20 | 0.20 | 0.20 | 0.20 |
| | | ECN-1280 | | pts. wt. | 0 | 0 | 0 | 0 | 0 | 0 |
| | | PLENLIZER ST210 | | pts. wt. | 0.10 | 0.10 | 0.10 | 0.10 | 0.10 | 0.10 |
| | | ANOX 20 | | pts. wt. | 0 | 0 | 0 | 0 | 0 | 0 |
| | | Ultranox 626 | | pts. wt. | 0 | 0 | 0 | 0 | 0 | 0 |
| | | SONGNOX 2450FF | | pts. wt. | 0.20 | 0.20 | 0.20 | 0.20 | 0.20 | 0.20 |
| | Lubricant | SC-P | | pts. wt. | 0.20 | 0.20 | 0.20 | 0.20 | 0.20 | 0.20 |
| | Water absorbing medium | BEN-GEL BLITE K11 | | pts. wt. | 0.40 | 0.40 | 0.40 | 0.40 | 0.40 | 0.40 |
| | | Carplex BS-304F | | pts. wt. | 0.40 | 0.40 | 0.40 | 0.40 | 0.40 | 0.40 |
| | Foaming agent | HFO-1234ze | | pts. wt. | 2.5 | 2.5 | 3.5 | 5.0 | 7.0 | 7.0 |
| | | Alcohol | Ethanol | pts. wt. | 0.5 | 0.5 | 0.7 | 1.0 | 1.0 | 1.0 |
| | | | i-propyl | pts. wt. | 0 | 0 | 0 | 0 | 0 | 0 |
| | | | alcohol | | | | | | | |

| | | Isobutane | pts. wt. | 1.6 | 1.6 | 1.6 | 0 | 0 | 0 |
|---|---|---|---|---|---|---|---|---|---|
| | | Dimethyl ether | pts. wt. | 4.0 | 4.0 | 3.4 | 3.8 | 3.0 | 0 |
| | | Ethyl chloride | pts. wt. | 0 | 0 | 0 | 0 | 0 | 0 |
| | | Water | pts. wt. | 0 | 0 | 0 | 0 | 0 | 0 |
| | Molar ratio of HFO-1234ze | HFO-1234ze | mol % | 66.9 | 66.9 | 66.9 | 66.9 | 73.9 | 73.9 |
| | and molar ratio of alcohol | Alcohol | mol % | 33.1 | 33.1 | 33.1 | 33.1 | 26.1 | 26.1 |
| Production | Foaming temperature | | ° C. | 121 | 118 | 120 | 120 | 119 | 120 |
| Conditions | Thickness of slit die | | mm | 6 | 6 | 6 | 5 | 5 | 5 |
| | Foaming pressure | | MPa | 3.0 | 3.0 | 3.0 | 4.0 | 4.0 | 4.0 |
| Physical | Thickness of styrene resin extruded foam | | mm | 60 | 110 | 60 | 60 | 60 | 60 |
| properties | (before cutting) | | | | | | | | |
| of | Apparent density | | kg/m3 | 32 | 31 | 32 | 34 | 34 | 33 |
| extruded | Closed cell ratio | | % | 95 | 95 | 96 | 95 | 95 | 95 |
| foam | Average cell diameter | | mm | 0.1 | 0.2 | 0.1 | 0.1 | 0.1 | 0.2 |
| | Cell deformation ratio | | — | 1.0 | 1.2 | 1.1 | 1.1 | 1.1 | 1.1 |
| | Amount of remaining HFO-1234ze relative to | | mol | 0.021 | 0.021 | 0.029 | 0.042 | 0.058 | 0.058 |
| | 100 g of styrene resin in extruded foam | | | | | | | | |
| | (immediately after production) | | | | | | | | |
| | Amount of remaining HFO-1234ze relative to | | mol | 0.016 | 0.018 | 0.027 | 0.039 | 0.056 | 0.056 |
| | 100 g of styrene resin in extruded foam (one | | | | | | | | |
| | week after the production) | | | | | | | | |
| | Thermal conductivity | | W/mK | 0.027 | 0.027 | 0.026 | 0.026 | 0.025 | 0.023 |
| | JIS flammability | | — | Good | Good | Good | Good | Good | Good |
| | Appearance | Shape | — | Good | Good | Good | Good | Good | Good |
| | of foam | Surface property | — | Good | Good | Good | Good | Good | Good |
| | | Determination Result | — | Accepted | Accepted | Accepted | Accepted | Accepted | Accepted |

TABLE 2

| | | | | | Example | Example | Example | Example | Example | Example |
|---|---|---|---|---|---|---|---|---|---|---|
| | | | | | 7 | 8 | 9 | 10 | 11 | 12 |
| Mixed | Base resin | Styrene resin A G9401 | | pts. wt. | 96.6 | 96.6 | 96.6 | 96.6 | 96.6 | 96.6 |
| | | Styrene resin B 630 | | pts. wt. | 0 | 0 | 0 | 0 | 0 | 0 |
| materials | Heat ray radiation inhibitor | Graphite masterbach A | | pts. wt. | 5.0 (2.5) | 5.0 (2.5) | 5.0 (2.5) | 5.0 (2.5) | 5.0 (2.5) | 5.0 (2.5) |
| | masterbach | Graphite masterbach B | | pts. wt. | 0 | 0 | 0 | 0 | 0 | 0 |
| | | Titanium oxide | | pts. wt. | 2.5 (1.5) | 2.5 (1.5) | 2.5 (1.5) | 2.5 (1.5) | 2.5 (1.5) | 2.5 (1.5) |
| | | masterbach A | | | | | | | | |
| | | Titanium oxide | | pts. wt. | 0 | 0 | 0 | 0 | 0 | 0 |
| | | masterbach B | | | | | | | | |
| | Flame retarder | GR-125P | | pts. wt. | 3.0 | 3.0 | 3.0 | 3.0 | 3.0 | 3.0 |
| | | EMERALD | | pts. wt. | 0 | 0 | 0 | 0 | 0 | 0 |
| | | INNOVATION #3000 | | | | | | | | |
| | Auxiliary flame retarder | Triphenylphosphine | | pts. wt. | 1.0 | 1.0 | 1.0 | 1.0 | 1.0 | 1.0 |
| | | oxide | | | | | | | | |
| | Radical generating agent | CCPIB | | pts. wt. | 0 | 0 | 0 | 0 | 0 | 0 |
| | Cell diameter adjusting | Talc | | pts. wt. | 0.20 | 0.20 | 0.20 | 0.20 | 0.20 | 0.20 |
| | agent | | | | | | | | | |
| | Stabilizerer | EP-13 | | pts. wt. | 0.20 | 0.20 | 0.20 | 0.20 | 0.20 | 0.20 |
| | | ECN-1280 | | pts. wt. | 0 | 0 | 0 | 0 | 0 | 0 |
| | | PLENLIZER ST210 | | pts. wt. | 0.10 | 0.10 | 0.10 | 0.10 | 0.10 | 0.10 |
| | | ANOX 20 | | pts. wt. | 0 | 0 | 0 | 0 | 0 | 0 |
| | | Ultranox 626 | | pts. wt. | 0 | 0 | 0 | 0 | 0 | 0 |
| | | SONGNOX 2450FF | | pts. wt. | 0.20 | 0.20 | 0.20 | 0.20 | 0.20 | 0.20 |
| | Lubricant | SC-P | | pts. wt. | 0.20 | 0.20 | 0.20 | 0.20 | 0.20 | 0.20 |
| | Water absorbing medium | BEN-GEL BLITE K11 | | pts. wt. | 0.40 | 0.40 | 0.40 | 0.40 | 0.40 | 0.40 |
| | | Carplex BS-304F | | pts. wt. | 0.40 | 0.40 | 0.40 | 0.40 | 0.40 | 0.40 |
| | Foaming agent | HFO-1234ze | | pts. wt. | 2.5 | 2.5 | 3.5 | 5.0 | 7.0 | 7.0 |
| | | Alcohol | Ethanol | pts. wt. | 0.5 | 0.5 | 0.7 | 1.0 | 1.0 | 1.5 |
| | | | i-propyl | pts. wt. | 0 | 0 | 0 | 0 | 0 | 0 |
| | | | alcohol | | | | | | | |

| | | Isobutane | pts. wt. | 1.6 | 1.6 | 1.6 | 0 | 0 | 0 |
|---|---|---|---|---|---|---|---|---|---|
| | | Dimethyl ether | pts. wt. | 4.0 | 4.0 | 3.4 | 3.8 | 3.0 | 3.0 |
| | | Ethyl chloride | pts. wt. | 0 | 0 | 0 | 0 | 0 | 0 |
| | | Water | pts. wt. | 0 | 0 | 0 | 0 | 0 | 0 |
| | Molar ratio of HFO-1234ze | HFO-1234ze | mol % | 66.9 | 66.9 | 66.9 | 66.9 | 73.9 | 65.3 |
| | and molar ratio of alcohol | Alcohol | mol % | 33.1 | 33.1 | 33.1 | 33.1 | 26.1 | 34.7 |
| Production | Foaming temperature | | ° C. | 120 | 118 | 120 | 119 | 121 | 119 |
| Conditions | Thickness of slit die | | mm | 6 | 6 | 6 | 5 | 5 | 5 |
| | Foaming pressure | | MPa | 3.0 | 3.0 | 3.0 | 4.0 | 4.0 | 4.0 |
| Physical | Thickness of styrene resin extruded foam | | mm | 60 | 110 | 60 | 60 | 60 | 60 |
| properties | (before cutting) | | | | | | | | |
| of | Apparent density | | kg/m3 | 32 | 31 | 33 | 35 | 35 | 35 |
| extruded | Closed cell ratio | | % | 95 | 95 | 96 | 95 | 95 | 95 |
| foam | Average cell diameter | | mm | 0.1 | 0.1 | 0.1 | 0.1 | 0.1 | 0.1 |
| | Cell deformation ratio | | — | 1.1 | 1.2 | 1.1 | 1.2 | 1.1 | 1.1 |
| | Amount of remaining HFO-1234ze relative to | | mol | 0.021 | 0.021 | 0.029 | 0.042 | 0.058 | 0.058 |
| | 100 g of styrene resin in extruded foam | | | | | | | | |
| | (immediately after production) | | | | | | | | |
| | Amount of remaining HFO-1234ze relative to | | mol | 0.018 | 0.018 | 0.027 | 0.039 | 0.056 | 0.056 |
| | 100 g of styrene resin in extruded foam (one | | | | | | | | |
| | week after the production) | | | | | | | | |
| | Thermal conductivity | | W/mK | 0.024 | 0.024 | 0.023 | 0.023 | 0.022 | 0.022 |
| | JIS flammability | | — | Good | Good | Good | Good | Good | Good |
| | Appearance | Shape | — | Good | Good | Good | Good | Good | Good |
| | of foam | Surface property | — | Good | Good | Good | Good | Good | Good |
| | | Determination Result | — | Accepted | Accepted | Accepted | Accepted | Accepted | Accepted |

*1: The values in parentheses each indicate an amount (unit: pts. wt.) of graphite or titanium oxide contained in the heat ray radiation inhibitor masterbatch, relative to 100 pts. wt. of the styrene resin.

TABLE 3

| | | | | | Compar- | Compar- | Compar- | Compar- | Compar- | Compar- |
|---|---|---|---|---|---|---|---|---|---|---|
| | | | | | ative | ative | ative | ative | ative | ative |
| | | | | | Example 1 | Example 2 | Example 3 | Example 4 | Example 5 | Example 6 |
| Mixed | Base resin | Styrene resin | | pts. wt. | 96.6 | 100 | 96.6 | 96.6 | 96.6 | 96.6 |
| materials | | A G9401 | | | | | | | | |
| | | Styrene resin | | pts. wt. | 0 | 0 | 0 | 0 | 0 | 0 |
| | | B 680 | | | | | | | | |
| | Heat ray radiation inhibitor | Graphite | | pts. wt. | 5.0 (2.5) | 0 | 5.0 (2.5) | 5.0 (2.5) | 5.0 (2.5) | 5.0 (2.5) |
| | masterbach | masterbach A | | | | | | | | |
| | (1*) | Graphite | | pts. wt. | 0 | 0 | 0 | 0 | 0 | 0 |
| | | masterbach B | | | | | | | | |
| | | Titanium oxide | | pts. wt. | 2.5 (1.5) | 0 | 2.5 (1.5) | 2.5 (1.5) | 2.5 (1.5) | 2.5 (1.5) |
| | | masterbach A | | | | | | | | |
| | | Titanium oxide | | pts. wt. | 0 | 0 | 0 | 0 | 0 | 0 |
| | | masterbach B | | | | | | | | |
| | Flame retarder | GR-125P | | pts. wt. | 3.0 | 3.0 | 3.0 | 3.0 | 3.0 | 3.0 |
| | | EMERALD | | pts. wt. | 0 | 0 | 0 | 0 | 0 | 0 |
| | | INNOVATION | | | | | | | | |
| | Auxiliary flame retarder | Triphenylphosphine | | pts. wt. | 1.0 | 1.0 | 1.0 | 1.0 | 1.0 | 1.0 |
| | | oxide | | | | | | | | |
| | Radical generating agent | CCPIB | | pts. wt. | 0 | 0 | 0 | 0 | 0 | 0 |
| | Cell diameter adjusting | Talc | | pts. wt. | 0.20 | 0.50 | 0.20 | 0.20 | 0.20 | 0.20 |
| | agent | | | | | | | | | |
| | Stabilizerer | EP-13 | | pts. wt. | 0.20 | 0.20 | 0.20 | 0.20 | 0.20 | 0.20 |
| | | ECN-1280 | | pts. wt. | 0 | 0 | 0 | 0 | 0 | 0 |
| | | PLENLIZER ST210 | | pts. wt. | 0.10 | 0.10 | 0.10 | 0.10 | 0.10 | 0.10 |
| | | ANOX 20 | | pts. wt. | 0 | 0 | 0 | 0 | 0 | 0 |
| | | Ultranox 626 | | pts. wt. | 0 | 0 | 0 | 0 | 0 | 0 |
| | | SONGNOX 2450FF | | pts. wt. | 0.20 | 0.20 | 0.20 | 0.20 | 0.20 | 0.20 |
| | Lubricant | SC-P | | pts. wt. | 0.20 | 0.20 | 0.20 | 0.20 | 0.20 | 0.20 |
| | Water absorbing medium | BEN-GEL | | pts. wt. | 0.40 | 0.40 | 0.40 | 0.40 | 0.40 | 0.40 |
| | | BLITE K11 | | | | | | | | |
| | | Carplex BS-304F | | pts. wt. | 0.40 | 0.40 | 0.40 | 0.40 | 0.40 | 0.40 |
| | Foaming agent | HFO-1234ze | | pts. wt. | 2.5 | 7.0 | 7.0 | 7.0 | 7.0 | 7.0 |
| | | Alcohol | Ethanol | pts. wt. | 0 | 0 | 0 | 1.5 | 0.2 | 1.8 |
| | | | i-propyl | pts. wt. | 0 | 0 | 0 | 0 | 0 | 0 |
| | | | alcohol | | | | | | | |

| | | Isobutane | pts. wt. | 1.6 | 0 | 0 | 0 | 0 | 0 |
|---|---|---|---|---|---|---|---|---|---|
| | | Dimethyl ether | pts. wt. | 2.8 | 2.8 | 2.8 | 0 | 3.8 | 2.2 |
| | | Ethyl chloride | pts. wt. | 0 | 0 | 0 | 0 | 0 | 0 |
| | | Water | pts. wt. | 0.9 | 0.7 | 0.7 | 0 | 0 | 0 |
| | Molar ratio of HFO-1234ze | HFO-1234ze | mol % | 100 | 100 | 100 | 65.3 | 93.4 | 61.1 |
| | and molar ratio of alcohol | Alcohol | mol % | 0 | 0 | 0 | 34.7 | 6.6 | 38.9 |
| Production | Foaming temperature | | ° C. | 121 | 120 | 119 | 119 | 119 | 116 |
| Conditions | Thickness of slit die | | mm | 6 | 5 | 5 | 5 | 5 | 5 |
| | Foaming pressure | | MPa | 3.0 | 4.0 | 4.0 | 4.0 | 4.0 | 4.0 |
| Physical | Thickness of styrene resin extruded foam | | mm | 110 | 40 | 30 | 30 | 30 | 60 |
| properties | (before cutting) | | | | | | | | |
| of | Apparent density | | kg/m3 | — | — | — | — | — | 34 |
| extruded | Closed cell ratio | | % | — | — | — | — | — | 95 |
| foam | Average cell diameter | | mm | 0.1 | 0.1 | 0.1 | 0.1 | 0.1 | 0.2 |
| | Cell deformation ratio | | — | — | — | — | — | — | 1.2 |
| | Amount of remaining HFO-1234ze relative to | | mol | 0.021 | 0.058 | 0.058 | 0.058 | 0.058 | 0.058 |
| | 100 g of styrene resin in extruded foam | | | | | | | | |
| | (immediately after production) | | | | | | | | |
| | Amount of remaining HFO-1234ze relative to | | mol | — | — | — | — | — | 0.056 |
| | 100 g of styrene resin in extruded foam (one | | | | | | | | |
| | week after the production) | | | | | | | | |
| | Thermal conductivity | | W/mK | — | — | — | — | — | 0.022 |
| | JIS flammability | | — | — | — | — | — | — | Poor |
| | Appearance | Shape | — | Poor | Poor | Poor | Poor | Poor | Good |
| | | | | Undulating | Undulating | Undulating | Undulating | Undulating | |
| | of foam | Surface property | — | Poor | Poor | Poor | Poor | Poor | Good |
| | | | | with crack | with crack | with crack | with crack | with crack | |
| | | | | and partial | and partial | and partial | and partial | and partial | |
| | | | | peeling | peeling | peeling | peeling | peeling | |
| | | Determination Result | — | Rejected | Rejected | Rejected | Rejected | Rejected | Accepted |

*1: The values in parentheses each indicate an amount (unit: pts. wt.) of graphite or titanium oxide contained in the heat ray radiation inhibitor masterbatch, relative to 100 pts. wt. of the styrene resin.

As is clear from Comparative Examples 1 to 3, use of an increased amount of a hydrofluoroolefin and further, addition of a heat ray radiation inhibitor deteriorate the moldability of an extruded foam. Meanwhile, it is clear from a comparison between Examples 1 through 6 and Comparative Example 2, a comparison between Example 8 and Comparative Example 1, and a comparison between Examples 10 through 15 and Comparative Example 3, that the moldability of an extruded foam can be improved by adding a hydrofluoroolefin and an alcohol at specific molar ratios, respectively. It is also clear from a comparison between Examples 7 through 9 and Comparative Example 1, that an appearance of an extruded foam can be improved by adding a hydrofluoroolefin and an alcohol at specific molar ratios, respectively.

As is clear from Comparative Example 4, even in a case where a hydrofluoroolefin and an alcohol are added at specific molar ratios, respectively, the moldability improving effect cannot be obtained when not all of the saturated hydrocarbon having 3 to 5 carbon atoms, dimethyl ether, and alkyl chloride (ethyl chloride) are used.

Furthermore, as is clear from Comparative Example 5, in a case where (i) the molar ratio of the hydrofluoroolefin is too high and outside the specific range of the hydrofluoroolefin and (ii) the molar ratio of the alcohol is too low and outside the specific range of the alcohol, the moldability improving effect cannot be exhibited. Meanwhile, as is clear from Comparative Example 6, in a case where (i) the molar ratio of the hydrofluoroolefin is too low and outside the specific range of the hydrofluoroolefin and (ii) the molar ratio of the alcohol is too high and outside the specific range of the alcohol, the flame retardancy of the extruded foam is deteriorated.

As a whole, it is clear from Examples 1 through 18 that in a case where in a styrene resin, which has an apparent density of not less than 20 kg/m³ and not more than 45 kg/m³ and a closed cell ratio of not less than 90%, (i) a flame retarder is contained in an amount in a specific range; (ii) a hydrofluoroolefin and an alcohol is added at specific molar ratios, respectively; and (iii) at least one selected from the group consisting of a saturated hydrocarbon having 3 to 5 carbon atoms, dimethyl ether, and alkyl chloride is used, it is possible to easily obtain a styrene resin extruded foam which has an excellent heat insulating property (i.e., a thermal conductivity of not more than 0.028 W/mK), an excellent flame retardancy, a beautiful surface, and a sufficient thickness suitable for use.

In view of a heat insulating property which is indicated by a thermal conductivity, Examples 6 through 18 may be used, and Examples 11 through 18 may also be used, out of Examples 1 through 18.

A styrene resin extruded foam in accordance with one or more embodiments of the present invention has an excellent heat insulating property, an excellent flame retardancy, a beautiful appearance, and a sufficient thickness suitable for use. Therefore, it is possible to suitably use the styrene resin extruded foam as a heat insulating material for a house or a structure.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A styrene resin extruded foam, comprising:
a styrene resin;
a flame retarder;
a hydrofluoroolefin;
an alcohol; and
at least one selected from the group consisting of a saturated hydrocarbon having 3 to 5 carbon atoms, dimethyl ether, and alkyl chloride,
wherein an amount of the flame retarder is 0.5 to 8.0 parts by weight relative to 100 parts by weight of the styrene resin,
wherein the styrene resin extruded foam has an apparent density of 20 to 45 kg/m³ and a closed cell ratio of not less than 90%,
wherein an amount of the hydrofluoroolefin added is 65 to 90 mol % relative to 100 mol % in total of the hydrofluoroolefin and the alcohol which are added, and
wherein an amount of the alcohol added is 10 to 35 mol % relative to 100 mol % in total of the hydrofluoroolefin and the alcohol which are added.

2. The styrene resin extruded foam according to claim 1, wherein an amount of the hydrofluoroolefin added to 100 parts by weight of the styrene resin is 3.0 to 14.0 parts by weight.

3. The styrene resin extruded foam according to claim 1, further comprising 1.0 to 5.0 parts by weight of graphite relative to 100 parts by weight of the styrene resin.

4. The styrene resin extruded foam according to claim 1, wherein the alcohol is at least one selected from the group consisting of ethanol, propyl alcohol, and i-propyl alcohol.

5. The styrene resin extruded foam according to claim 1,
wherein the styrene resin extruded foam comprises the saturated hydrocarbon having 3 to 5 carbon atoms, and
wherein an amount of the saturated hydrocarbon having 3 to 5 carbon atoms added to 100 parts by weight of the styrene resin is 1.0 to 3.0 parts by weight.

6. The styrene resin extruded foam according to claim 1, wherein the hydrofluoroolefin is a tetrafluoropropene.

7. The styrene resin extruded foam according to claim 1, having a thickness of 10 to 150 mm.

8. The styrene resin extruded foam according to claim 1, wherein the flame retarder is a bromine flame retarder, and wherein an amount of the bromine flame retarder is 0.5 to 5.0 parts by weight relative to 100 parts by weight of the styrene resin.
